(19) United States
(12) Patent Application Publication
(10) Pub. No.: US 2013/0014964 A1
(43) Pub. Date: Jan. 17, 2013

(54) FIRE EXTINGUISHER GAS EJECTOR

(71) Applicant: Hideo Yoshida, Tokorozawa-shi (JP)

(72) Inventor: Hideo Yoshida, Tokorozawa-shi (JP)

(21) Appl. No.: 13/638,921

(22) PCT Filed: Mar. 1, 2011
(86) PCT No.: PCT/JP2011/001177

§ 371 Date: Oct. 1, 2012

(30) Foreign Application Priority Data
Mar. 30, 2010 (JP) 2010077614

(51) Int. Cl. A62C 13/76

(52) U.S. Cl. 169/89

(57) ABSTRACT

For a vehicle there is provided a fire extinguisher gas ejector combined with a device for cutting a seat belt rapidly and a device for breaking open a windshield reliably to facilitate a prompt escape from a vehicle compartment in an emergency, such as a vehicle fire and collision, the fire extinguisher gas ejector includes a gas cylinder in which a seal can be broken safely and easily without necessitating a safety member for preventing seal breaking while not in use and removing operation thereof, prevents fire extinguishing gas from being wasted after the seal is broken, emits the fire extinguishing gas to a fire origin reliably and accurately, and whereby early fire extinction can be achieved. The fire extinguisher gas ejector promptly alerts people of a problem, such as a vehicle fire at night, and ensures an emergency response and safety thereof.

### FIELD OF THE INVENTION

The present invention relates to a fire extinguisher gas ejector which is suitable for a vehicle, the ejector is combined with a device for cutting a seat belt rapidly and a device for breaking open a windshield reliably to facilitate a prompt escape from a vehicle compartment in an emergency, such as a vehicle fire and collision. A gas cylinder of the fire extinguisher gas ejector can be punctured safely and easily without requiring a safety member for preventing a seal from breaking while not in use and without requiring removing operation thereof. The fire extinguisher gas ejector prevents fire extinguishing gas from being wasted after the seal is broken, emits the fire extinguishing gas to a fire origin reliably and accurately, and whereby early fire extinction can be achieved. The fire extinguisher gas ejector promptly alerts people of a problem, such as a vehicle fire at night, and ensures an emergency response and safety thereof.

### BACKGROUND ART

Conventionally, fire extinguishers commonly installed at homes and industrial plant facilities are generally hard to use because they are large and heavy and require force to operate. Therefore, in order to solve the abovementioned problems, various simple fire extinguishers, small, light, and easy to use, have been proposed.

For example, one such simple fire extinguisher comprises a gas cylinder received inside a pipe body with a cover attached, a dish-shaped nozzle formed with a jetting hole being provided at the lower end of the gas cylinder, a pusher guide body attached to the top end of the pipe body, a pusher provided with a firing pin being slidably mounted to the guide body, a cylinder receiver attached inside the pusher guide body, a mouth screw of the gas cylinder screwed into the receiver, and a safety plate normally inserted in the pusher for preventing the movement thereof.

In case of a fire, the safety plate is removed and then the outside of the pusher is pressed inwardly with a hand. The firing pin which is moved to the gas cylinder side pierces the sealing plate. The gas discharged from the gas cylinder is introduced from the pipe body to the inside of the shaft body, and then the gas is emitted from the jetting hole on the opposite side of the breaking position (refer, for example, to Patent Document 1).

However, the above-described fire extinguisher requires the safety plate for preventing the seal from breaking while not in use. Operation of the safety plate is difficult when a user has to extinguish a fire immediately. Further, it is difficult to pull out the safety plate and takes a time for seal breaking because the tab is small. After the seal is broken, the emitted gas is introduced to the space between the pipe body and the gas cylinder and then emitted from the jetting hole on the opposite side of the seal breaking position. As a result, the jetting pressure and the jetting speed is attenuated and performance of fire extinction is lowered, and thereby making difficult to extinguish a fire in early stages. Further, the gas remains unused in the pipe body after seal breaking so that the full amount of the filled gas cannot be used.

Another such simple fire extinguisher comprises a housing for receiving a gas cylinder screwed into an upper cover body and being movable up and down, a stopper engageable with the lower end of the upper cover body being provided on the upper part of the housing to prevent upward movement of the housing in normal times, an insertion part with a firing pin attached being protruded downward from the upper cover body, a cylinder fitting to which the gas cylinder may be screwed provided at the top end of the housing, and the tip portion of the firing pin positioned immediately above a sealing plate of the gas cylinder. In order to extinguish a fire, the housing is rotated upwardly to break the seal with the stopper pressed and then the extinguishing gas is discharged from the jetting hole (refer, for example, to Patent Document 2).

However, the above-described fire extinguishers requires the stopper for preventing seal breaking while not in use. Another problem is that the housing needs to be rotated multiple times for seal breaking, making the seal breaking difficult and time-consuming, and whereby prompt fire extinction cannot be achieved. Further, it is difficult to emit the fire extinguishing gas accurately to a fire origin because the fire extinguishing gas is emitted instantaneously after the seal is broken. Thus, early fire extinction is made difficult.

To solve the abovementioned problems, the applicant has invented a fire extinguisher which comprises a cylinder holder in which a gas cylinder is disposed in an upper and a lower cases, a needle tube provided movable in the direction close to or away from a protruded seal breaking holder, a control valve provided in a communication with a passage in the seal breaking holder and being closed in normal times, wherein the fire extinguishing gas emitted after seal breaking is stored in a through hole of the cylinder holder and the passage of the seal breaking holder, the gas is discharged from a jetting hole upon opening of the control valve by operation of an actuation lever, and whereby the gas is emitted to a fire origin reliably (refer, for example, to Patent Document 3). The above fire extinguisher emits the fire extinguishing gas reliably and effectively to a fire origin after the seal is broken, however, requires a safety ring for preventing the seal from breaking while not in use between the upper and lower cases, whereby the number of components is increased and removing operation of the safety ring takes time and trouble.

On the other hand, there have been desired simple fire extinguishers which can be installed at homes or offices as well as vehicles, and which can respond to a vehicle fire. In such a case, there is a demand for simple fire extinguishers used in a vehicle to be equipped with an escape device from a vehicle compartment in addition to a device for fire extinction in an emergency, such as a collision.

Due to such demands recently, the applicant developed a fire extinguisher which comprises a cylinder holder capable of holding the gas cylinder and the cylinder holder being equipped with a seal breaking pipe which is movable up and down, an outer pipe mounted outside the cylinder holder and provided at one side with a seat belt introduction groove and a cutter, and a hammer member provided at an exposed bottom of the gas cylinder, wherein upon a fire, the seal of the gas cylinder is broken to emit the fire extinguishing gas to respond to a vehicle, fire, wherein upon an emergency, such as a collision, a seat belt is inserted in the seat belt introduction groove to cut the belt and release the upper limb, a windshield is smashed and broken by the hammer member to escape from a vehicle compartment (refer, for example, to Patent Document 4).

The fire extinguisher comprises an escape device for escaping from the vehicle compartment in an emergency, such as a vehicle fire, so that it responds to an emergency. However, when such a problem occurs at night, the fire extinguisher does not have a means to inform persons of the problem promptly and there is a danger of inducing a traffic accident. Thus, improvements have been desired in this respect.

### PATENT DOCUMENTS

Patent Document 1 Japanese Patent No. 2890097
Patent Document 2 Japanese Unexamined Patent Application Publication No. 9-103512.
Patent Document 3 Japanese Unexamined Patent Application Publication No. 2007-330775
Patent Document 4 WO2009/050847 A1

### SUMMARY OF THE INVENTION

It is an object of the present invention to solve the aforementioned problems and to provide a fire extinguisher gas ejector which is suitable for a vehicle, combined with a device for cutting a seat belt rapidly and a device for breaking open a windshield reliably to facilitate a prompt escape from a vehicle compartment in an emergency, such as a vehicle fire and collision. A gas cylinder of the fire extinguisher gas ejector can be punctured safely and easily without requiring a safety member for preventing a seal from breaking while not in use and without requiring removing operation thereof. The fire extinguisher gas ejector prevents fire extinguishing gas from being wasted after the seal is broken, emits the fire extinguishing gas to a fire origin reliably and accurately, and whereby early fire extinction can be achieved. The fire extinguisher gas ejector promptly alerts persons of a problem, such as a vehicle fire at night, and ensures an emergency response and safety thereof.

The present invention in a first aspect thereof comprises a seal-breaking device, the seal-breaking device comprises, a housing which defines an outer shape and formed from a translucent member either transparent or semi-transparent, a gas cylinder filled with fire extinguishing gas, sealed with a sealing plate and provided with a mouth portion removably attached thereto, a cylinder holder formed therein with a through hole, a needle tube which slidably moves in the through hole, and provided at one end thereof with a tip portion capable of piercing the sealing plate, a communication hole which is in communication with the needle tube, the through hole, and a nozzle hole which is open to outside, and a plurality of lamp fittings disposed on an interior of the housing and capable of flashing or lighting. In the construction as described, persons are alerted for a problem immediately in an emergency, such as a vehicle fire at night and collision, and thus emergency measures can be taken and safety can be ensured. The present invention in a second aspect thereof comprises a cylindrical illuminator provided on the interior of the housing and the lamp fittings are disposed on a periphery of the cylindrical illuminator. In the construction as described, the light fittings are easily disposed, assembled, and wired.

The present invention in a third aspect thereof comprises an actuation lever having a contact point and rotatably provided on the housing, and a contact panel capable of being contacted with the contact point and being provided on the periphery of the cylindrical illuminator, in the construction as described, the light fittings are easily operable, and opening/closing of the electric circuit in two contact points is structured simply and at low costs. In a fourth aspect of the present invention, the lamp fittings flash or light via rotational operation of the actuation lever before or after seal breaking of the gas cylinder. The construction responds to a vehicle fire and an emergency at night in addition to the vehicle fire. In a fifth aspect of the present invention, the contact point is formed with either a coil spring or a plate spring. In the construction as described, unsteadiness or deviation in operational displacement of the actuation lever 6 can be tolerated. Further, the present invention provides flexibility in contact between the contact point and the contact panel so that the light fittings reliably flash or light.

The present invention in a sixth aspect thereof comprises two cam pins protruded diametrically from a periphery of the cylinder holder, two helical cam grooves disposed symmetrically on the periphery of the cylindrical illuminator, wherein the cam pins are slidably engaged with the cam grooves and the cylinder holder is rotatably mounted on an interior of the cylindrical illuminator. In the construction as described, the seal is broken by the rotational operation of the as cylinder. In a seventh aspect of the present invention, each cam groove extends about 90 degrees on the periphery of the cylindrical illuminator. Compared with the conventional structures, in which the gas cylinder needs to be rotated multiple times for seal breaking, the seal is broken quickly. Further, less space is required for seal breaking. The present invention in an eighth aspect thereof comprises an engaging piece engageable with one of the cam pins and protruded from a lower end of each cam groove, and capable of being bent or broken. In the construction as described, the engaging piece is structured as a seal-breaking prevention means and the seal-breaking prevention can be easily released by breaking or bending the engaging piece. Further, this construction eliminates trouble of releasing the seal-breaking prevention, which is a problem of conventional structures, and the seal can be broken quickly.

In a ninth aspect of the present invention, the engaging piece and the cylindrical illuminator are formed integrally and the seal-breaking prevention means and the cylindrical illuminator are formed integrally. This construction eliminates a need of a separate structure of the seal-breaking prevention means, which is a conventional structure. Further, the number of components is reduced and the structure is simplified so that the present invention can be manufactured easily and at low costs. In a tenth aspect of the present invention, the engaging piece is movable up and down. In the construction as described, the engaging piece can be utilized without being broken or bent so that convenience of the seal-breaking device is improved. In an eleventh aspect of the present invention, after seal breaking, the cam pins are moved to the lower end of each cam groove so as to restrict movement of the cam pins, and whereby, the gas cylinder is replaceable. This construction prevents the seal from breaking when replacing the gas cylinder with a new one. In a twelfth aspect of the present invention, at least one of the cam pins is formed in a tubular shape, and a lock pin is inserted into the tubular cam pin from outside of the seal-breaking device, whereby the lock pin is restricted. This construction prevents the cylinder holder to which the lock pin is secured from rotating and prevents the seal from breaking when replacing the gas cylinder with a new one.

In a thirteenth aspect of the present invention, the housing is provided at one side thereof with the rotatable actuation lever and at the other side thereof with a seat belt introduction groove, and a cutter is provided to face the seat belt introduction groove. In the construction as described, the seatbelt can be cut readily in a vehicle emergency, such as a collision. Further, this construction facilitates a prompt escape from a vehicle compartment. The present invention in a fourteenth aspect thereof comprises a seat belt releasing portion having a substantially inverted-triangular cross section and provided in a rear of the seat belt introduction groove so that the seat belt can be cut smoothly and readily. Further, this construction facilitates a prompt escape from a vehicle compartment in an emergency.

The present invention in a fifteenth aspect thereof comprises a battery for the lamp fittings received in a lower inside at the other side of the housing. In the construction as described, the space in the housing can be used effectively and the seal-breaking device can be made compact. In a sixteenth aspect of the present invention, the communication hole is provided with a control valve which is normally closed and openable via operation of the actuation lever. In the construction as described, the extinguishing gas after seal breaking stays once in the communication hole and the through hole to prevent the extinguishing gas from being wasted. Further, the extinguishing gas can be emitted to a fire origin accurately via operation of the actuation lever so that the fire can be extinct at early stages. The present invention in a seventeenth aspect thereof comprises a hammer member having a pointed portion provided on a bottom of the gas cylinder for breaking open a windshield of a vehicle. In the construction as described, the windshield can be smashed reliably via the hammer member in a vehicle emergency, such as a vehicle fire and collision, so that people can escape from the vehicle compartment readily and safety can be ensured.

### ADVANTAGES OF THE INVENTION

According to the invention of claim 1, the housing is made of translucent member either transparent or semi-transparent and a plurality of lamp fittings are disposed on an interior of the housing to flash or light. As a result, persons are alerted immediately when a problem occurred, such as a vehicle fire at night, and an emergency response so that safety can be ensured. According to the invention of claim 2, a plurality of lamp fittings are disposed on an interior of the housing. As a result, the light fittings are easily disposed, assembled, and wired. According to the invention of claim 3, an actuation lever has a contact point and is rotatably provided on the housing, and a contact panel is capable of being contacted with the contact point and being provided on the periphery of the cylindrical illuminator. As a result, the light fittings are easily operable, and opening/closing of the electric circuit in two contact points is structured simply and at low costs. According to the invention of claim 4, the lamp fittings flash or light via rotational operation of the actuation lever before or after seal breaking of the gas cylinder. As a result, the construction responds to a vehicle fire as well as an emergency at night other than the vehicle fire. According to the invention of claim 5, the contact point is formed by either a coil spring or a plate spring. As a result, unsteadiness and deviation in operational displacement of the actuation lever 6 can be tolerated. Further, the construction provides flexibility in contact between the contact point and the contact panel so that the lamps fittings are reliably flash or light. According to the invention of claim 6, two cam pins are protruded diametrically from a periphery of the cylinder holder, two helical cam grooves are disposed symmetrically on the periphery of the cylindrical illuminator, wherein the cam pins are slidably engaged with the cam grooves and the cylinder holder is rotatably mounted on an interior of the cylindrical illuminator. As a result, the seal is broken by rotational operation of the gas cylinder. According to the invention of claim 7, each cam groove extends about 90 degrees on the periphery of the cylindrical illuminator. As a result, compared with the conventional structures, in which the gas cylinder needs to be rotated multiple times for seal breaking, the seal can be broken quickly. Further, less space is required for the seal breaking. According to the invention of claim 8, an engaging piece is engageable with one of the cam pins and protruded from a lower end of each cam groove, and is capable of being bent or broken. As a result, the engaging piece functions as a seal-breaking prevention means and seal-breaking prevention can be easily released by breaking or bending the engaging piece. Further, this construction eliminates trouble of releasing the seal-breaking prevention, which is a problem of conventional structures, and seal breaking can be performed quickly.

According to the invention of claim 9, the engaging piece and the cylindrical illuminator are formed integrally and the seal-breaking prevention means and the cylindrical illuminator are formed integrally. This construction eliminates a need of a separate structure of the seal-breaking prevention means, which is a conventional structure. As a result, the number of components is reduced and the structure is simplified so that the present invention can be manufactured easily and at low costs. According to the invention of claim 10, the engaging piece is movable up and down. As a result, the engaging piece can be reused without being broken or bent, and further, convenience of the seal-breaking device is improved. According to the invention of claim 11, after seal breaking, the cam pin is moved to the lower end of each cam groove so as to restrict movements of the cam pin, and whereby the gas cylinder is replaceable. As a result, the seal is prevented from breaking when replacing the gas cylinder with a new one. According to the invention of claim 12, at least one of the cam pins is formed in a tubular shape, and a lock pin is inserted into the tubular cam pin from outside of the seal-breaking device, whereby the lock pin is restricted. As a result, this construction prevents the cylinder holder to which the lock pin is secured from rotating, and prevents the seal from breaking when replacing the gas cylinder with a new one. According to the invention of claim 13, the housing is provided at one side thereof with the rotatable actuation lever and at the other side thereof with a seat belt introduction groove, and a cutter is provided to face the seat belt introduction groove. As a result, the seatbelt can be cut readily in a vehicle emergency, such as a collision. Further, this construction facilitates a prompt escape from a vehicle compartment. According to the invention of claim 14, a seat belt releasing portion has a substantially inverted-triangular cross section and is provided in a rear of the seat belt introduction groove so that a seat belt can be cut smoothly and readily. As a result, this construction facilitates a prompt escape from a vehicle compartment in an emergency. According to the invention of claim 15, a battery for the lamp fittings is received in a lower inside at the other side of the housing. As a result, the space in the housing can be used effectively and the seal-breaking device can be made compact.

According to the invention of claim 16, the communication hole is provided with a control valve which is normally closed and openable via operation of the actuation lever. As a result, the extinguishing gas after seal breaking stays once in the communication hole and the through hole to prevent the extinguishing gas from being wasted. Further, the extinguishing gas can be emitted to a fire origin accurately via operation of the actuation lever so that a fire can be extinct at early stages. According to the invention of claim 17, a hammer member which has a pointed portion is provided on a bottom of the gas cylinder for breaking open a windshield of a vehicle. As a result, a windshield can be smashed reliably via the hammer member in a vehicle emergency, such as a vehicle fire or collision, so that people can escape from a vehicle compartment readily and safety can be ensured.

### BRIEF DESCRIPTION OF THE DRAWINGS

FIG. 1 is a perspective view in accordance with an embodiment of the present invention and showing a state in which the seal-breaking device is attached to the gas cylinder.

FIG. 2 is an elevation view of FIG. 1.

FIG. 3 is a cross sectional view taken along line A-A of FIG. 2 and showing a state in which power circuits for the lamps are open.

FIG. 4 is a cross-sectional view taken along line B-B of FIG. 2.

FIG. 5 is an exploded perspective view of the principal part of the present invention.

FIG. 6 is an enlarged cross sectional view of the seal-breaking device and showing a state in which power circuits for the lamp are open.

FIG. 7 is an elevation view of the cylindrical illuminator applied to the present invention.

FIG. 8 is a plan view of FIG. 7.

FIG. 9 is a cross sectional view taken along line C-C of FIG. 7.

FIG. 10 is a right side view of FIG. 7.

FIG. 11 is a rear view of FIG. 7.

FIG. 12 is an explanatory view showing movements of the cam pin. FIG. 12 (a) is a normal state of the cam pin, in which one of the cam pins is positioned to engage with the engaging piece. FIG. 12 (b) is a state in which the cam pin is engaged with the engaging piece, and operation of seal breaking is started and the engaging piece is bent. FIG. 12 (c) is a state in which the cam pin is engaged with the engaging piece and the engaging piece is bent, and seal breaking-prevention is released. FIG. 12 (d) is a state immediately before seal breaking, in which the bent engaging piece falls in the cam groove and the engaging pin is moved upwardly further.

FIG. 13 is an explanatory view of seal breaking. FIG. 13 (a) is a normal state before the seal is broken. FIG. 13 (b) shows a state in which the gas cylinder is rotated and moved upwardly, during seal breaking. FIG. 13 (c) is a state immediately after the seal is broken, with the gas cylinder rotated to the top position.

FIG. 14 is an enlarged cross sectional view of the hammer member attached to the bottom of the gas cylinder of the present invention.

FIG. 15 is an elevation view showing a state in which the seat belt is cut with the seatbelt introduction groove and the cutter provided for the present invention.

FIG. 16 is an enlarged cross sectional view of the seat belt being cut with the seatbelt introduction groove provided for the present invention.

FIG. 17 is an elevation view showing a state in which a windshield is broken with the hammer member provided for the present invention.

FIG. 18 is an elevation view showing a state in which the actuation lever provided for the present invention is operated to light or flash the lamps.

FIG. 19 is a cross sectional view showing a state in which the actuation lever provided for the present invention is operated to light or flash the lamps before the seal is broken.

FIG. 20 is a cross sectional view showing a state in which the actuation lever provided for the present invention is operated to light or flash the lamps, and the extinguishing gas is emitted after seal breaking.

FIG. 21 is an elevation view of the cylindrical illuminator applied to the other embodiment of the present invention.

FIG. 22 is an explanatory view showing movements of one of the can pins applied toother embodiment. FIG. 22 (a) is a normal state of the cam pin which is positioned to engage with the engaging piece. FIG. 22 (b) is a state in which the one of the cam pins is engaged with the engaging piece and the engaging piece is bent immediately after seal breaking operation is started. FIG. 22 (c) is a state immediately before seal breaking, in which the cam pin has engaged with the engaging piece and the engaging piece has moved downward and returned to its original position. FIG. 22 (d) is a state in which the seal is broken with the cylinder holder rotated about 90 degrees. FIG. 22 (e) is a state in which the cylinder holder is rotated about 90 degrees in the reverse direction after the seal is broken and the cam pin is returned to its original position, and a state in which the cylinder is replaced, with the lock pin inserted in the cam pin to restrict the movement.

FIG. 23 is a cross sectional view showing a state in which the cam pin is restricted by the lock pin.

### DESCRIPTION OF THE EMBODIMENTS

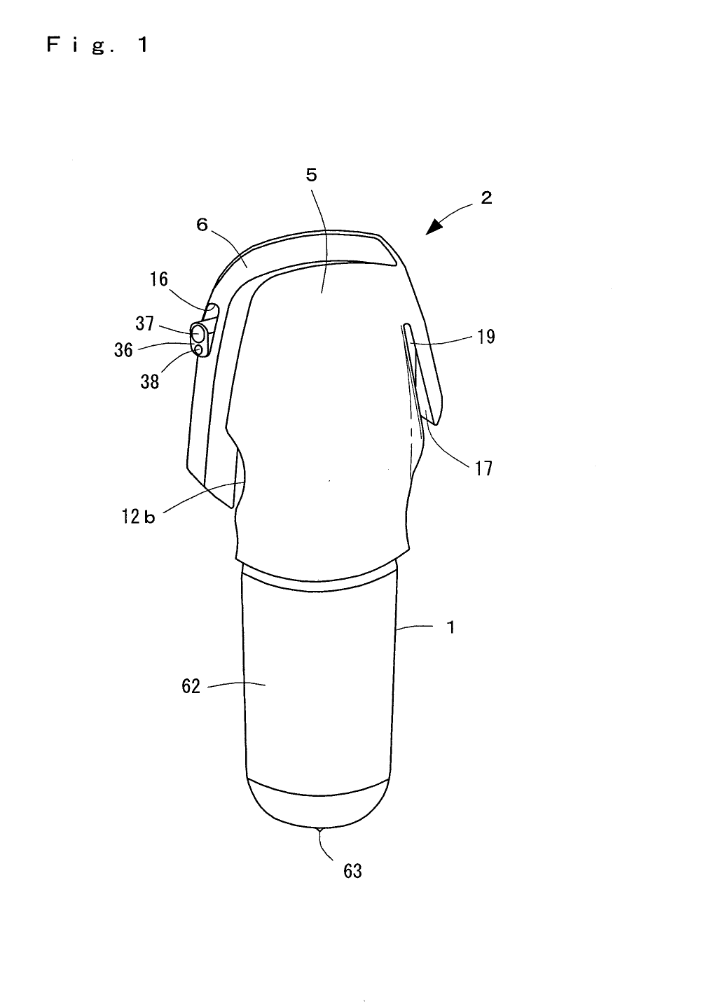

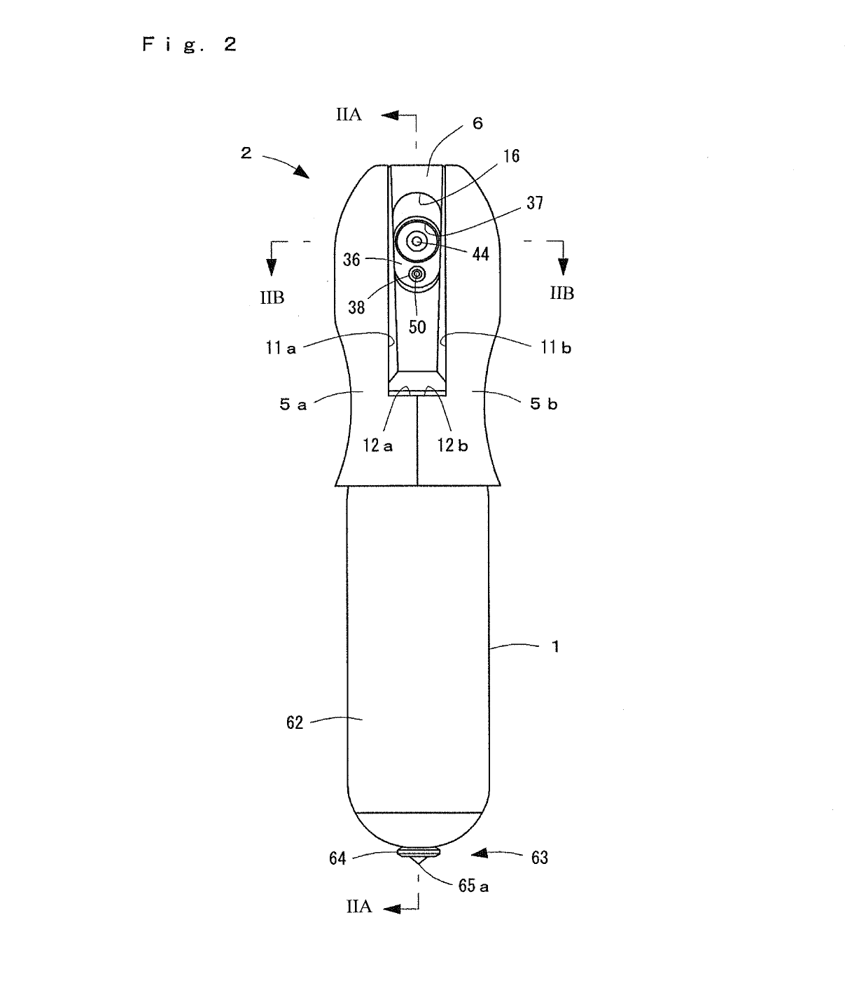

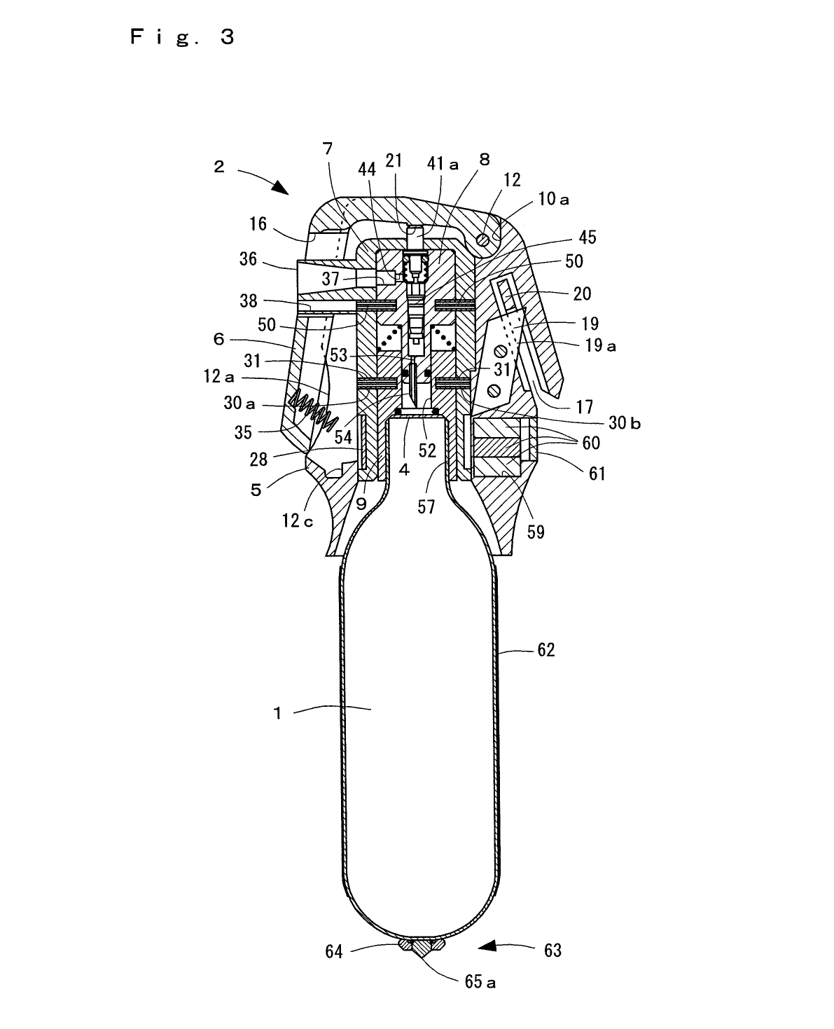

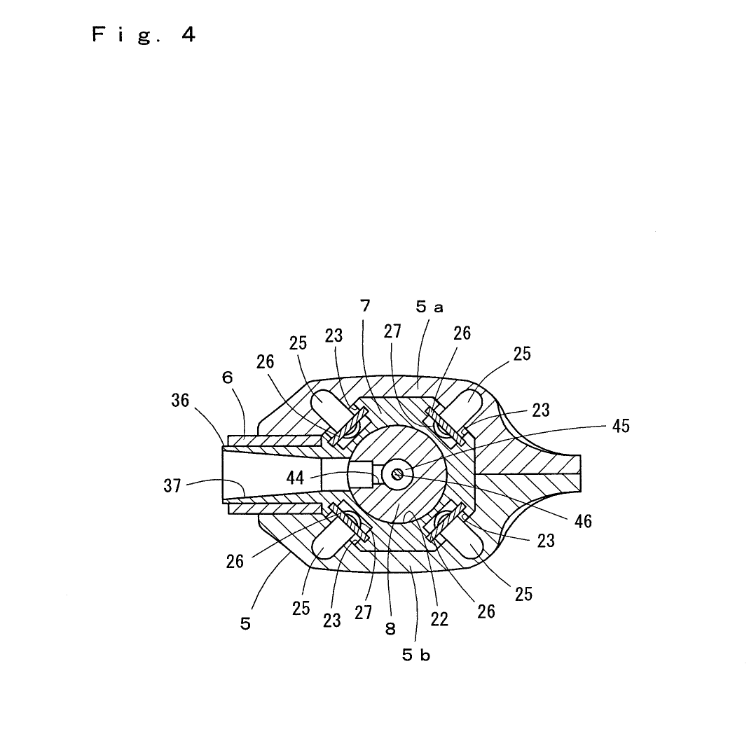

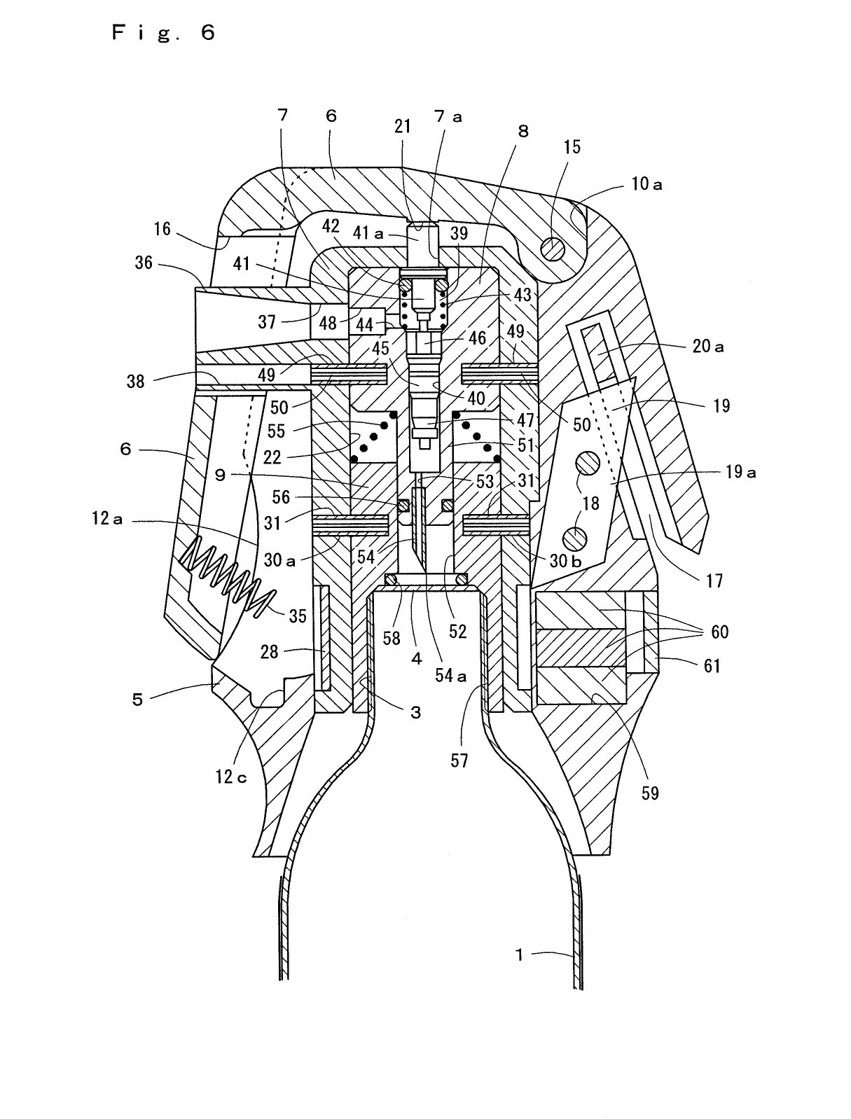

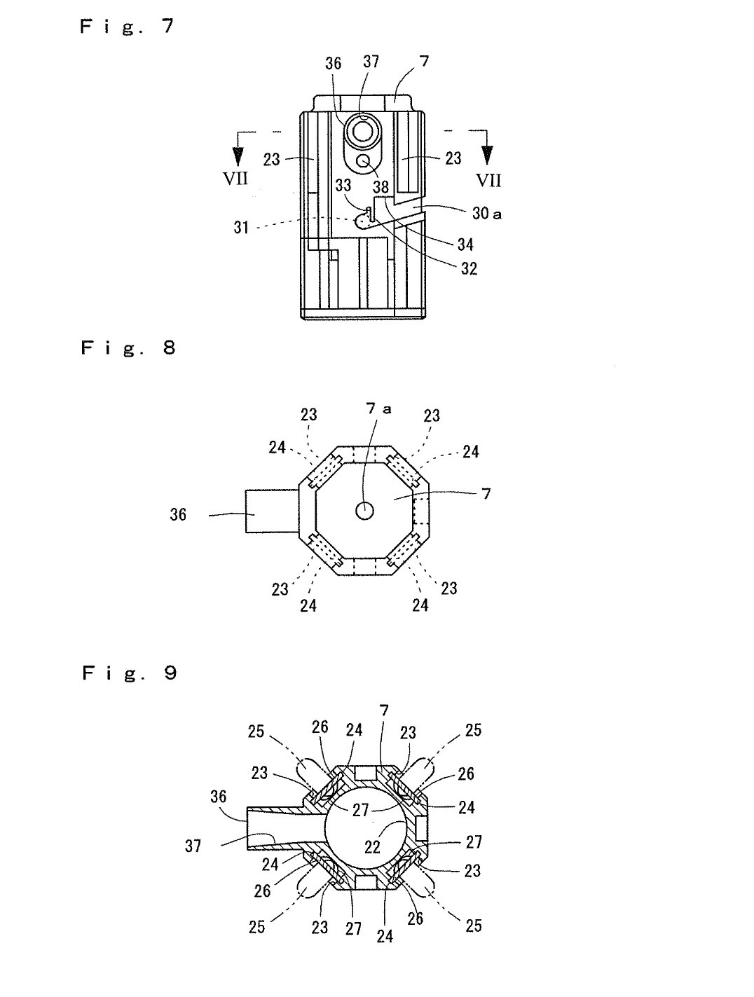

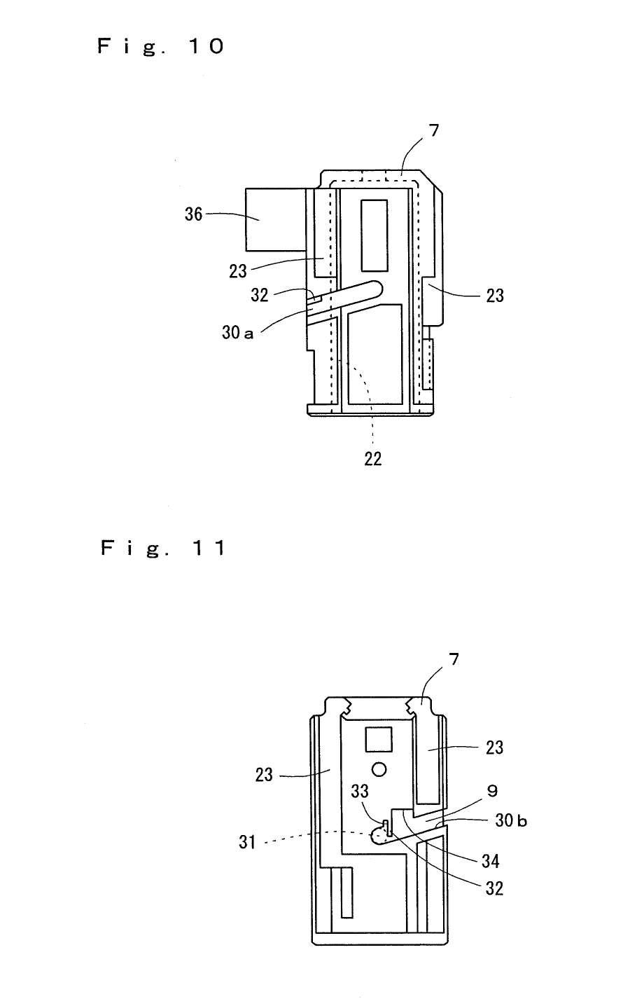

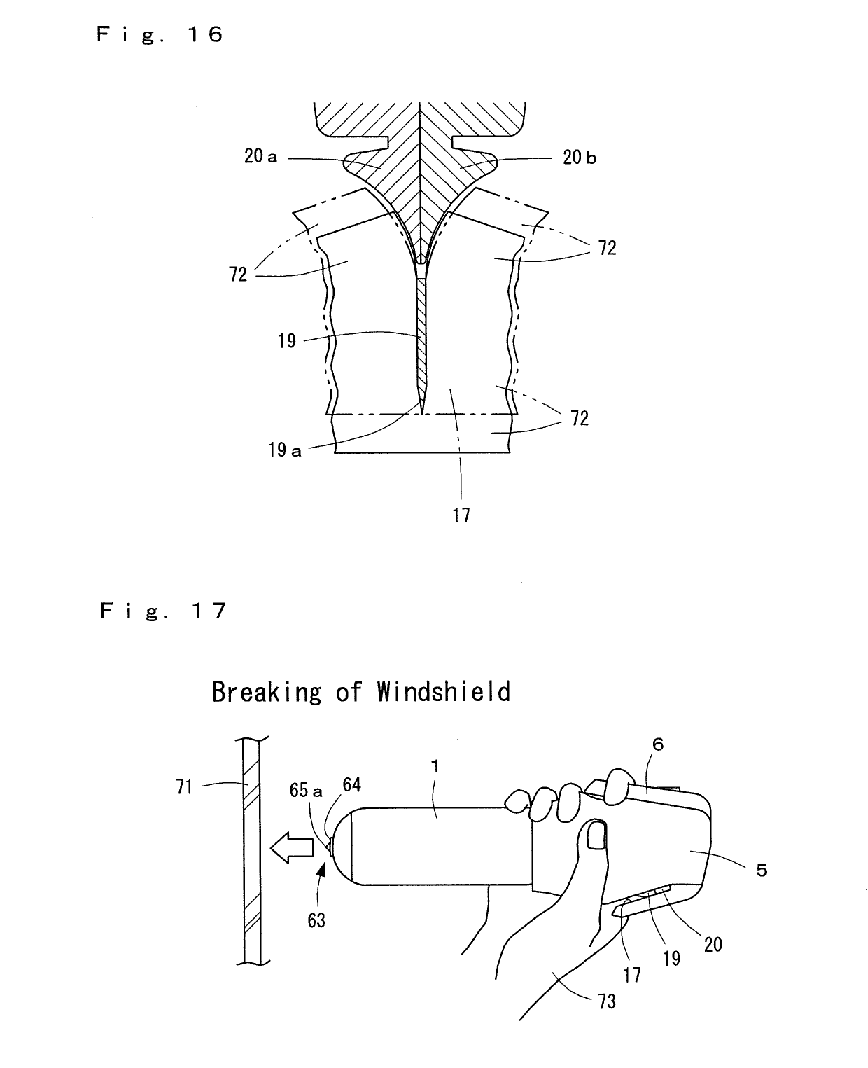

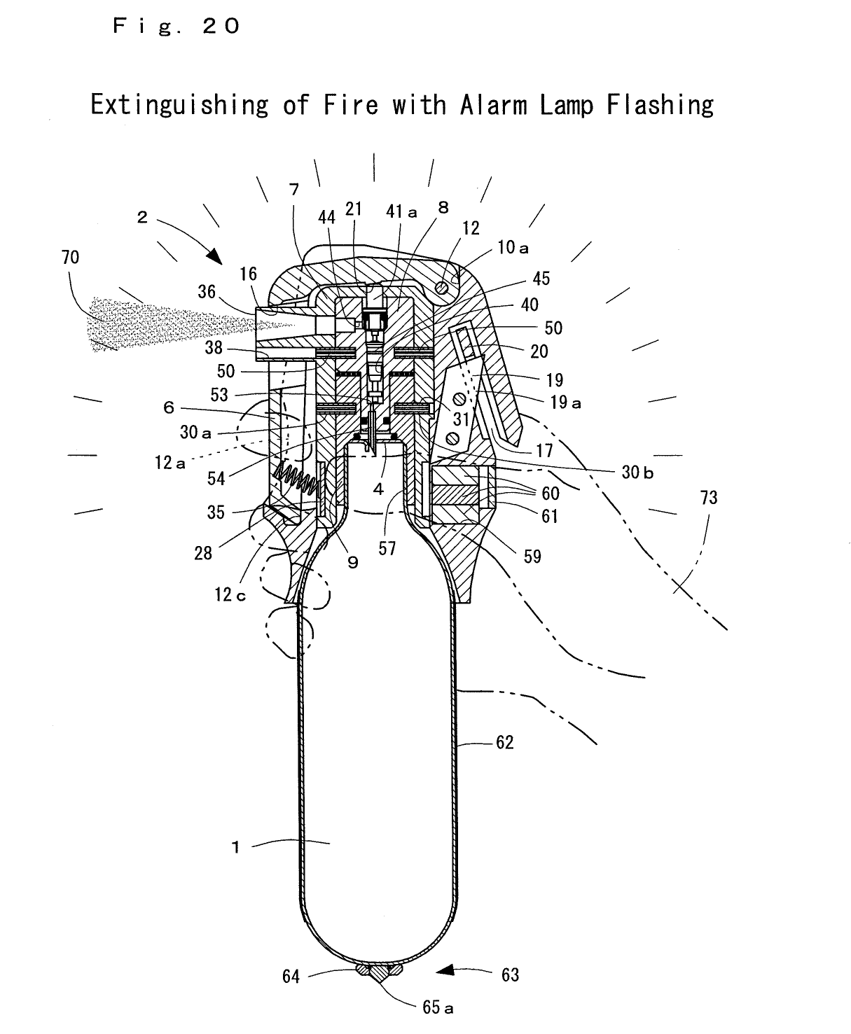

In the illustrated embodiment, the present invention is applied to a fire extinguisher gas ejector for a vehicle in which a cartridge gas cylinder is used. In FIGS. 1 to 20, reference numeral 1 denotes a small gas cylinder filled therein with carbon dioxide as fire extinguishing gas, and a thread portion 3 is formed on a mouth portion of the gas cylinder 1. The thread portion 3 is screwed into the lower part of the seal-breaking device 2. The gas cylinder 1 in the embodiment is of about 40 mm in outer diameter, about 130 mm in length, and about 90 ml in tare weight and is filled therein with carbon dioxide of about 4 MPa and about 300 g in weight after filling. After the gas is filled, the mouth portion is sealed with a sealing plate 4, and then a hammer, as described later, is attached to the bottom.

The seal-breaking device 2 comprises a housing 5 made of synthetic resin and defines a shape of an outer shell, an actuation lever 6 made of synthetic resin and attached to the periphery of the housing 5 and being movable up and down, a cylindrical illuminator 7 made of synthetic resin and received in the housing 5, a seal breaking holder 8 received inside the cylindrical illuminator 7, and a cylinder holder 9 which holds the gas cylinder 1.

The housing 5 is made of translucent synthetic resin either transparent or semi-transparent and is of a cylindrical shape. The housing 5 comprises a pair of housing pieces 5a, 5b split vertically and is formed by attaching them to each other. Joining surfaces of the housing pieces 5a, 5b are respectively formed with engaging grooves 10a, 10b, 11a, 11b, and curved concave grooves 12a, 12b. Pin holes 12 are formed on the upper end of the engaging grooves 11a, 11b, respectively. In drawings, reference numerals 12c, 12d denote engaging walls formed on the inner side of the lower end of the curved concave grooves 12a, 12b and are provided to engage with the lower end of the actuation lever 6.

Housing pieces 5a, 5h are respectively provided on the inner surfaces with engaging grooves 13 engageable with the outer peripheral surface of the cylindrical illuminator 7 and engaging grooves 14 engageable with a plurality of the alarm lamps mounted to the cylindrical illuminator 7. Many dents (not shown) are formed on the inner surface of the engaging grooves 14 and formed like a dotted pattern, or grain finish is also possible, and whereby the lights of the alarm lamps are diffusely reflected.

The actuation lever 6 is made of translucent synthetic resin either transparent or semi-transparent and is of virtually L-shape. The upper end of the actuation lever 6 is provided with a projection 6a having a semicircular column shape, and a pin 15 is projected from the projection 6a. The actuation lever 6 is slidably provided between the grooves 10a, 10b and 11a, 11b, and is rotatable about the pin 15 inserted in the pin hole 12. The actuation lever 6 is normally biased to rotate forwardly by the resilience of a spring bearing, as described later. Moreover, the lower end of the actuation lever 6 or an operating part is provided on the curved concave grooves 12a, 12b.

In drawings, reference numeral 16 denotes an elongated through hole formed on the middle of the actuation lever 6, and an ejector pipe as described later protruded from the cylindrical illuminator 7 is insertable in the through hole. Reference numeral 17 denotes a seatbelt introduction groove provided on the back of the housing pieces 5a, 5h. A pair of pins 18 is protruded from the positions adjacent the seatbelt introduction groove and a cutter 19 is mounted on the pins 18. The blade 19a is provided obliquely to face the seatbelt introduction groove 17.

Pieces 20a, 20b for a seatbelt releasing portion having an inverted triangular shape are protruded from the back of the seatbelt introduction groove 17 and the back side of the pieces 20a, 20b are increased in width. The pieces 20a, 20b are joined to each other when the housing pieces 5a, 5b are attached together. Additionally, in drawings, reference numeral 21 denotes a projection provided on the undersurface of the upper part of the actuation lever 6 and is provided to engage with a spring bearing, as described later.

The cylindrical illuminator 7 has a hollow portion 22 inside and generally an octagonal column shape and is provided with four lamp-fitting grooves 23. The grooves 23 have a vertically elongated rectangular shape and arranged at equiangular positions on the outer periphery of the upper half. Basal-plate fitting grooves 24 are formed on the middle part of the lamp-fitting grooves 23. A basal plate 26 to which two alarm lamps 25 are attached may be inserted or removed from the basal-plate fitting groove 24. In the embodiment, red LEDs are used for alarm lamps because they require less power consumption, have high directivity, and invites attention of persons. The LEDs are arranged at two positions, the upper and lower positions of the basal plate 26, and a wiring 27 for the LEDs is provided on the back side of the basal plate 26.

In drawings, reference numeral 28 denotes a contact panel provided on the lower part on the front surface of the cylindrical illuminator 7 and is connected to the basal plate 26 via wiring 29, in order to establish a power circuit with a battery, as described later, the contact panel 28 is made contact with a contact point 35 which is a coil spring or a leaf spring provided on the lower end of the inner side of the actuation lever 6, then the alarm lamps 25 are turned on for lighting and flashing, in this embodiment, each LED lamp is adapted to flash in appropriate intervals.

One end of the contact point 35 is attached to the inner surface of the actuation lever 6, and the other end is a free end and moves simultaneously with the actuation lever 6, and thereby providing flexibility when contacting the contact panel 28. The alarm lamps 25 are turned off when the other end is moved away from the contact panel 28. When the actuation lever 6 is held with a hand and rotated about the pin 15, the contact point 35 contacts the contact panel 28, and whereby the alarm lamps 25 is turned on. In this embodiment, the contact point 35 is turned off after being contacted with the contact panel 28 and releasing the contact and then making the contact again. Helical cam grooves 30a, 30b having the same shape each other are formed at symmetrical positions on the middle to the upper part of the cylindrical illuminator 7. The cam grooves 30a, 30b are formed within an area approximately 90 degrees from the center of the hollow portion 22 or the cylinder holder 9. The tips of cam pins 31, 31, for example, spring pin, are engageably and slidably inserted in the cam grooves 30a, 30b. In this case, it is preferable to form concave portions engageable with the cam pins 31, 31 at the top positions of the cam grooves 30a, 30b to prevent movement of the cam pins 31, 31 after seal breaking.

The cam pins 31 are provided protruded in the diametrical direction of the cylinder holder 9 and reside at the bottom of the cam grooves 30a, 30b before the seal of the gas cylinder 1 is broken. Engaging pieces 32, 32 are protruded downward from the lower end of the cam grooves 30a, 30b. The engaging pieces 32, 32 are provided to engage with the cam pins 31, 31. Cutout grooves 33, 34 are formed at either one side or both sides of the base plate to facilitate bending or breaking of the engaging pieces 32, 32. It is possible to provide the cutout groves 33, 34 on one side or both sides of the adjacent position of the base plate. In this embodiment, the engaging pieces 32, 32 are broken and fall in the cam grooves 32, 32. The engaging pieces 32, 32 may be bent and received in the cutout groove 34.

An ejector pipe 36 is protruded from the upper front of the cylindrical illuminator 7 and inserted in a through hole 16 of the actuation lever 6, and thus allows the actuation lever 6 to rotate. A jetting hole 37 that is in communication with a nozzle hole, and a pin hole 38 for inserting an engaging pin, as described later, are provided on the end face of the ejector pipe 36. The pin hole 38 is positioned below the jetting hole 37.

The seal breaking holder 8 is made of aluminum and of a cylindrical shape. A spring housing 39 and a communication hole 40 of different sizes are formed in the seal breaking holder 8 and are in communication with each other. A spring bearing 41 is engageably inserted in the spring housing 39 on the upper side and slidable up and down. The shaft portion 41a is inserted in a through hole 7a on the ceiling part of the cylindrical illuminator 7 and protruded to engage with the projection 21. An O-ring 42 and a spring 43 are provided inside the spring housing 39 and the spring bearing 41 is biased upwardly due to the resilience of the spring 43. In addition, the lower end of the spring bearing 41 is positioned to engage with the top of a push rod of a control valve, as described later. Upon actuation of the actuation lever 6, the push rod is pressed down so as to open the control valve. A nozzle hole 44 that is in communication with the jetting hole 37 is formed on the lower part of the spring housing 39. The fire extinguishing gas is discharged from the nozzle hole 44 when the control valve is open.

A screw hole (not shown) is formed on the middle part of the communication hole 40. A thread portion (not shown) formed on the middle periphery of the control valve 45 is threaded into the screw hole to attach the control valve 45 air tightly. The control valve 45 comprises a push rod 46 that passes through the inside and an inner valve 47 that moves simultaneously with the push rod 46. They are biased upwardly via a valve spring (not shown) inside, and the control valve 45 is normally closed by an inner valve 47 pressed into contact with the main body of the control valve. In drawings, reference numeral 48 denotes an ejection guide opened on the periphery of the seal breaking holder 8 and reference numeral 44 denotes a nozzle hole formed at the back of the ejection guide. Reference numerals 49, 49 denote pin holes formed at the diametric positions on the periphery of the seal breaking holder 8. Engaging pins 50, 50 are protruded from the pin holes 49, 49, and the outer end portions are engaged with the predetermined positions of the cylindrical illuminator 7.

A guide rod 51 having a small diameter is protruded from the bottom of the seal breaking holder 8, the guide rod 51 is slidably inserted in the through hole 52 of the cylinder holder 9. A through hole 53 which is in communication with the communication hole 40 is formed inside the guide rod 51 and a base part of the needle tube 54 is inserted in the through hole 53. The tip portion 54a is positioned immediately above the sealing plate 4. In drawings, reference numeral 55 denotes a spring interposed between the seal breaking holder 8 and the cylinder holder 9. Reference numeral 56 denotes an O-ring attached to the periphery of the lower end of the guide rod 51. The cylinder holder 9 is formed in a cylindrical body that has the same diameter with the seal breaking holder 8. A pin hole 9a is formed at the diametric position on the middle of the cylinder holder 9 and the pin 31 is insertable therein. A thread hole 57 which is in communication with the through hole 52 is formed on the lower end of the cylinder holder 9, and the thread portion 3 of the gas cylinder 1 is screwable into the thread hole 57. In drawings, reference numeral 58 denotes an O-ring interposed between the lower end of the through hole 52 and the sealing plate 4. Additionally, in drawings, reference numerals 59 denote pockets formed inside the back of the housing pieces 5a, 5b and a plurality of batteries 60, power sources for the alarm lamps 25, are received therein. An opening portion can be opened or closed with a cover 61. Reference numeral 62 denotes a sheet that covers the outer surface of the gas cylinder 1 and is made of an insulating film. How to use the fire extinguisher of the present invention with pictures is printed on the surface. In this embodiment, the sheet 62 is made of synthetic resin film and formed by shrinking the film at the predetermined temperature and attached to the surface of the gas cylinder 1 filled with carbon dioxide.

A hammer member 63 having a pointed portion is attached to the bottom of the gas cylinder 1 and the hammer member 63 comprises a retaining ring 64 made of steel, and a hammer shaft 65 made of a hard steel member which has been subjected to quenching. The retaining ring 64 is formed generally in a dish shape and a through hole 66 is formed on the center of the ring 64. After attaching the retaining ring 64 to the bottom of the gas cylinder 1 by welding, the hammer shaft 65 together with a C-ring 67 or a stopper is inserted in the through hole 66. After insertion, the C-ring 67 is engaged with a tapered surface 68 on the inner rim of the through hole 66 to secure the hammer shaft 65 rigidly.

The hammer shaft 65 is longer than the height of the retaining ring 64 and an annular groove 69 or a neck portion is formed on the base part. A pointed portion 65a is formed at the end and is protruded from the retaining ring 64. Welding of the retaining ring 64 is carried out after filling the carbon dioxide in the gas cylinder 1 at the predetermined pressure and after sealing the mouth portion with the sealing plate 4. The gas cylinder 1 and the retaining ring 64 are plated at a time after welding of the retaining ring 64.

Thereafter, the hammer shaft 65 that has been quenched and plated are prepared. An adhesive is applied to the periphery of the hammer shaft 65. The C-ring 67 having a circular cross section and elasticity is compressed and fitted in the annular groove 69 and then is inserted in the through hole 66 of the hammer shaft 65 maintaining the resilience of the C-ring 67. After insertion of the C-ring 67, the spherical surface of the C-ring 67 is engaged with the tapered surface 68 of the inner rim of the through hole 66 and the C-ring 67 is pressed in contact with the tapered surface 68 and thereby creating a wedge effect. The adhesive is applied in the space between the gas cylinder 1, the C-ring 67, and the hammer shaft 65 and is solidified to attach the hammer shaft 65 tightly and rigidly. In this case, the retaining ring 64 is attached to the gas cylinder 1 by welding. By hooking the retaining ring 64 to the hammer shaft 65, welding the hammer shaft 65 to the gas cylinder 1 and plating thereof are avoided. Thus, the periphery of the gas cylinder 1 is prevented from being damaged by the pointed portion 65a of the hammer shaft 65 when the hammer shaft 65 is welded to the gas cylinder 1 and when they are plated.

Additionally, in drawings, reference numeral 70 denotes a jet of fire extinguishing gas emitted outside after the seal is broken, reference numeral 71 denotes a windshield of a vehicle, reference numeral 72 denotes a seat belt attached in a vehicle compartment, and reference numeral 73 denotes a hand of a user. When the alarm lamps 25 flash or light, a user needs to hold the fire extinguisher gas ejector and informs persons of an accident. In such a situation, a magnet (not shown) may be attached to the appropriate position of, for example, the housing 5 so that the magnet may be attached to the appropriate position on the surface of the vehicle, and thereby reducing burden of informing persons.

The fire extinguisher gas ejector thus configured comprises the seal-breaking device 2 attached to the upper part of the small gas cylinder 1 and the hammer member 63 for escaping in an emergency attached to the bottom of the small gas cylinder 1. The seal-breaking device 2 comprises the housing 5 made of synthetic resin having translucency either transparent or semi-transparent, the actuation lever 6 which is rotatably mounted to the periphery of the housing 5, the cylindrical illuminator 7 received in the housing 5, the seal breaking holder $ received in the cylindrical illuminator 7, and the cylinder holder 9 which holds the gas cylinder 1. The ejector pipe 36 is disposed on the front of the seal-breaking device 2 and the seat belt introduction groove 17 and the cutter 19 are equipped on the back portion.

The hammer member 63 is attached in the following manner. Carbon dioxide is filled in the gas cylinder 1 at the predetermined pressure, as described, and the mouth portion is sealed with the sealing plate 4. Then, the retaining ring 64 is welded to the bottom of the gas cylinder 1 and they are plated. Thereafter, the adhesive is applied to the periphery of the hammer shaft 65, the C-ring 67 is fitted in the annular groove 69, and the hammer shaft 65 is inserted in the through hole 66 maintaining the resilience. After insertion of the C-ring 67, the spherical surface of the C-ring 67 is engaged with the tapered surface 68 of the inner rim of the through hole 66, and the C-ring 67 is pressed in contact with the tapered surface 68. The adhesive is applied in the space between the gas cylinder 1, the C-ring 67, and the hammer shaft 65, and is solidified to attach the hammer shaft 65 tightly and rigidly.

After attaching the hammer member 47, the sheet 62 is attached to the middle periphery of the gas cylinder 1 and placed in a furnace at the predetermined temperature. The film is shrunk by heating in the furnace and attached to the middle periphery of the gas cylinder 1.

Next, in order to manufacture the seal-breaking device 2, a pair of housing pieces 5a, 5b is formed by vertically halving the synthetic resin which is either transparent or semi-transparent. The engaging grooves 10a, 10b, 11a, 11b and curved concave grooves 12a, 12h are formed on the joining surfaces of the housing pieces 5a, 5b, and the pin holes 12 are formed on the upper ends of the engaging grooves 11a, 11b, respectively. The engaging grooves 13, 14 are formed on the inner sides of the housing pieces 5a, 5b. The engaging grooves 13 are engageable with the outer periphery of the cylindrical illuminator 7. The engaging grooves 14 are engageable with the alarm lamps 25. Many dents are formed on the inner surface of the engaging grooves 14 and thrilled like a dotted pattern, or grain finish is also possible. Further, the seatbelt introduction groove 17 and seatbelt releasing portion 20a, 20h are formed on the back portion.

The actuation lever 6 is formed with the same synthetic resin as the housing 5 and is of substantially an L-shape, and the pin 15 is projected from the top end. The through hole 16 which is vertically elongated is formed on the middle part of the lever 6. The base part of the contact point 35, which is a coil spring, is attached to the inner surface of the lower end of the lever 6. The cylindrical illuminator 7 has generally an octagonal column shape and is made of the same synthetic resin as the housing 5. Four lamp-fitting grooves 23 and the basal-plate fitting grooves 24 are formed on the periphery of the cylindrical illuminator 7. The helical cam grooves 30a, 30b are formed symmetrically on the middle to upper periphery of the cylindrical illuminator 7. The engaging pieces 32, 32 are protruded downward from the lower ends of the helical cam grooves 30a, 30b, and the cutout grooves 33, 34 are formed on both sides of the upper base plate of the engaging pieces 32, 32. Further, the ejector pipe 36 is projected from the front part of the cylindrical illuminator 7. Then red LEDs or alarm lamps 25, the basal plates 24 for fitting the lamps 25, and leads for wiring 27 are prepared to arrange the alarm lamps 25 up and down positions on the surface of the basal plates 24. Each lead 27 is provided on the back side and the basal plate 24 is fitted within the basal-plate fitting groove 24. The wiring 27 is received in the back side and a feeding line 29 is pulled out to be connected to the contact panel 28.

The seal breaking holder 8 and the cylinder holder 9 are made of aluminum and formed in the same diameter. The communication hole 40 is formed in the seal breaking holder 8 in the axial direction and the nozzle hole 44 which is in communication with the communication hole 40 is provided laterally. Additionally, the spring bearing 41 is disposed on top of the communication hole 40. The shaft portion 41a is inserted in the through hole 7a, which is on the ceiling of the cylindrical illuminator 7, and protruded there from. The O-ring 42 and the spring 43 are disposed below the flange so that the spring bearing 41 is air tight and biased upwardly. At the same time, the control valve 45 is attached in the communication hole 40 by screwing.

The guide rod 51 having a small diameter is protruded from the lower end of the seal breaking holder 8 and the through hole 53 which is in communication with the communication hole 40 is formed therein. The needle tube 54 is inserted in the through hole 53 and the tip portion 54a is provided downwardly. The through hole 52 and a thread hole 57 having a large diameter are formed in the cylinder holder 9.

Then, the seal breaking holder 8 and the cylinder holder 9 are inserted in the hollow portion 22 of the cylindrical illuminator 7, and a spring 55 is interposed there between. A pin 50 is inserted in the pin hole 38 and then inserted in the seal breaking holder 8 so that the seal breaking holder 8 is secured to the upper inside of the cylindrical illuminator 7. On the other hand, pins 31, 31 are inserted in the lower ends of the cam grooves 30a, 30h of the cylindrical illuminator 7 and then inserted in the pin holes 9a of the cylinder holder 9. The cylinder holder 9 is attached to the lower part of the cylindrical illuminator 7 to move helically.

Next, the actuation lever 6 is provided between the housing pieces 5a, 5b and the ejector pipe 36 of the cylindrical illuminator 7 is inserted in the through hole 16. The cam pins 31 at the top end are inserted in pin holes 12 and the actuation lever 6 is rotatable about the cam pins 31. The lower surface of the top part is engaged with the shaft portion 41a and the actuation lever 6 is biased to rotate forwardly. The cutter 19 is mounted on the pins 18, 18 at the back of the housing pieces 5a, 5b and the blade 19a is provided to face the seatbelt introduction groove 17. The housing pieces 5a, 5b are attached together by joining the parts.

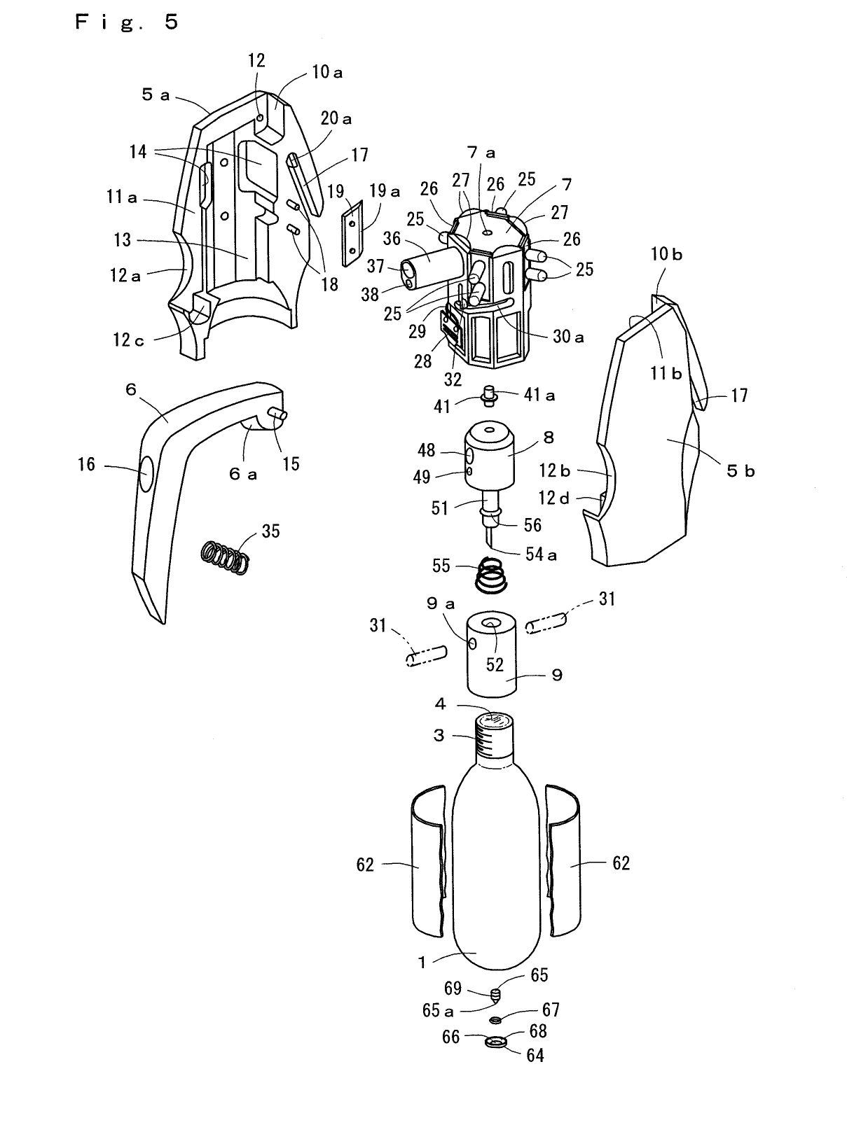

The seal-breaking device 2 thus configured is about 90 mm in height, about 60 mm in longitudinal length, and about 50 mm in outer diameter. The cylindrical illuminator 7 in which the alarm lamps 25 are attached is provided in the housing 5 and the seal breaking holder 8 is provided inside the cylindrical illuminator 7. The battery 60 is received in the lower inside at the housing 5. The contact point 35 is provided at the lower inside of the actuation lever 6. The housing 5 surrounds and protects the contact panel 28. The front surface is closed with the lower part of the actuation lever 6 such that entry of rain and wind can be prevented. Accordingly, wire disconnection and short-circuit or other wiring problems can be prevented and safety in rue can be secured. This state is shown in FIGS. 4 and 6.

Next, in order to attach the seal-breaking device 2 to the fire extinguisher gas ejector, the thread portion 3 of the gas cylinder 1 filled with the extinguishing gas is threaded into the thread hole 57 of the cylinder holder 9 of the seal-breaking device 2. The fire extinguisher gas ejector to which the gas cylinder 1 is mounted is shown in FIGS. 1 to 3 and is small and lightweight construction with about 183 mm in height and 460 g in weight. As opposed to the conventional structures, some components, such as a case for covering the gas cylinder 1 and a safety member for preventing a seal from breaking when not in use, are not required. Accordingly, the tire extinguisher gas ejector requires fewer parts, and therefore a simple and light construction can be achieved. Further, the fire extinguisher gas ejector can be produced easily and at low cost.

In the fire extinguisher gas ejector, the cutter 19 for cutting the seatbelt 72 is mounted to the seal-breaking device 2, and the hammer member 63 is mounted to the gas cylinder 1, which is an essential component for the fire extinguisher gas ejector, and thereby making a special escape device unnecessary. The fire extinguisher gas ejector is composed of an extinguishing device and an escape device. It is rationally constructed and easy to use. Further, the seal-breaking device 2 of the fire extinguisher gas ejector comprises the cylindrical illuminator 7 therein equipped with the alarm lamps 25. Accordingly, it responds to an emergency, such as vehicle problems at night, and whereby security is increased.

In the fire extinguisher gas ejector thus assembled, the seal breaking holder 8 is positioned above the cylinder holder 9 and the tip portion 54a of the needle tube 54 is positioned immediately above the sealing plate 4 when not in use, and thus the sealing plate 4 is not broken. Moreover, the control valve 45 provided inside the seal breaking holder 8 is closed and a communication between the communication hole 40 and the nozzle hole 44 is closed.

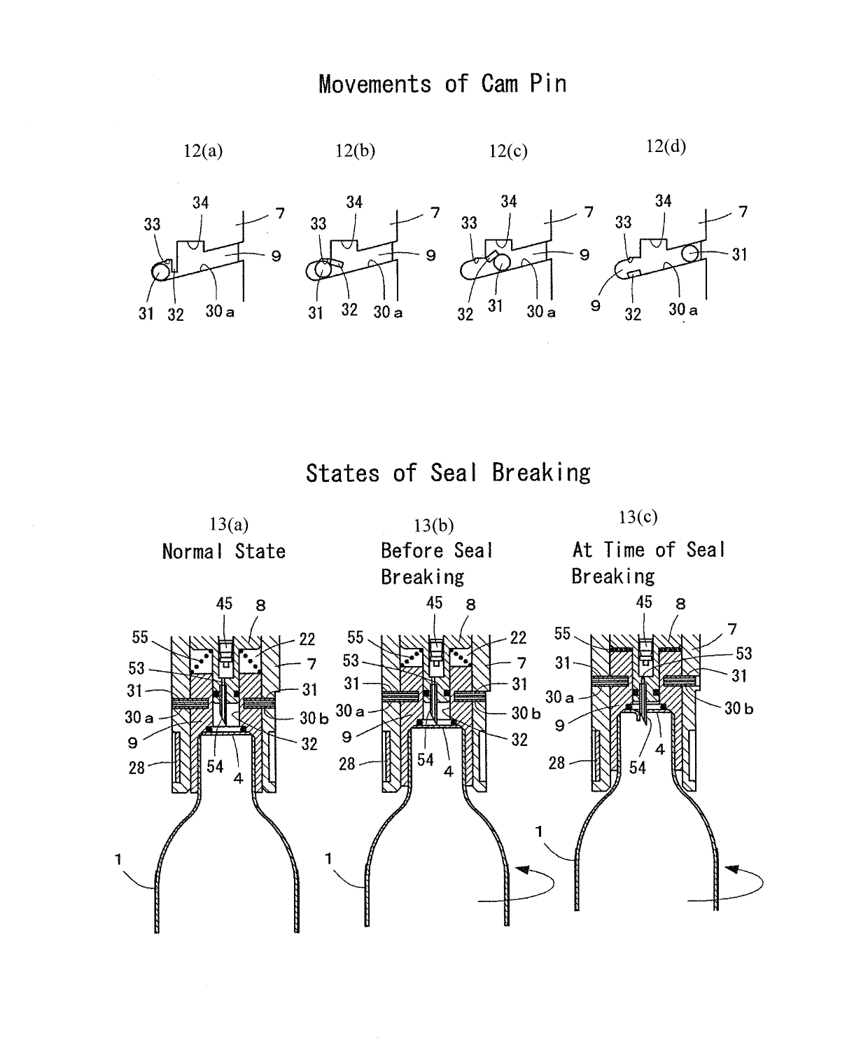

As shown in FIG. 12(a), the cam pins 31, 31 reside in the lower end portions of the cam grooves 30a, 30b when not in use, and the engaging pieces 32, 32 or seal-breaking prevention means are located at the adjacent positions. Accordingly, the cam pins 31, 31 are prevented from moving upwardly, and thereby the gas cylinder 1 is prevented from moving upwardly and the sealing plate 4 is prevented from breaking.

On the other hand, the actuation lever 6 is biased to rotate forwardly by the resilience of the spring bearing 41 and the lower end is positioned on the curved concave grooves 12a, 12b formed on the lower front part of the housing 5. The contact point 35 that is a coil spring is moved away from the contact panel 28 so that the power circuits for the alarm lamps 25 are open and the alarm lamps 25 are turned off.

When installing the fire extinguisher gas ejector thus assembled in a vehicle, it is installed horizontally or upright adjacent a driver's seat, a front seat, or other seats, for example, in a door pocket or a box adjacent a shift lever. In this case, the cross-section of the seal-breaking device 2 is formed in substantially an oval shape that is elongated in a front-back direction. This shape prevents the fire extinguisher gas ejector from rolling when placed horizontally, and further noise and damage can be prevented. The fire extinguisher gas ejector may be stored in a protective case such that the fire extinguisher gas ejector can be taken in and out of the case easily. Additionally, the appearance is improved and safety is improved.

Then, in the fire extinguisher gas ejector of the present invention, the engaging pieces 32 or a seal-breaking prevention means while not in use are provided inside the seal-breaking device 2 so that safety can be maintained regardless of the installed condition and the rolling of the tire extinguisher gas ejector. Accordingly, the conventional seal-breaking prevention means does not need to be attached to the surface of the fire extinguisher gas ejector. Thus, safety can be maintained because there is no danger that the seal-breaking prevention means would be removed due to the installed conditions or the rolling of the fire extinguisher gas ejector.

In a case where the seat belt 72 cannot be removed or a car door cannot be opened due to a traffic accident with the fire extinguisher gas ejector mounted in the car, the driver or the passenger needs to cut the seat belt 72 and/or break the windshield 71 to exit the vehicle compartment.

When cutting the seat belt 72, the tire extinguisher gas ejector is held with one hand directing the seatbelt introduction groove 17 of the seal-breaking device 2 laterally or diagonally forward. Moreover, the seat belt 72 is held with the other hand and then inserted in the seatbelt introduction groove 17. In this case, the seatbelt introduction groove 17 is open diagonally downward with respect to the axial direction of the seal-breaking device 2. The seat belt 72 can be inserted smoothly via a chevron-shaped portion immediate below the groove 17 compared with the structure in which the groove 17 is open vertically downward. Thereafter, the edge of the seatbelt 72 is brought into contact with the blade 19a of the cutter 19 and the seal-breaking device 2 is pulled quickly to cut the seat belt 72.

Upon cutting the seat belt 72, the blade 19a of the cutter 19 is disposed substantially at an acute angle with respect to the introduction direction of the seat belt 72. Thus, the blade 19a of the cutter 19 cuts the edge of the seat belt 72 at an acute angle and thus facilitates the smooth cutting compared with the structure in which the blade 19a of the cutter 19 is disposed substantially at a right angle with respect to the seatbelt introduction groove 72.

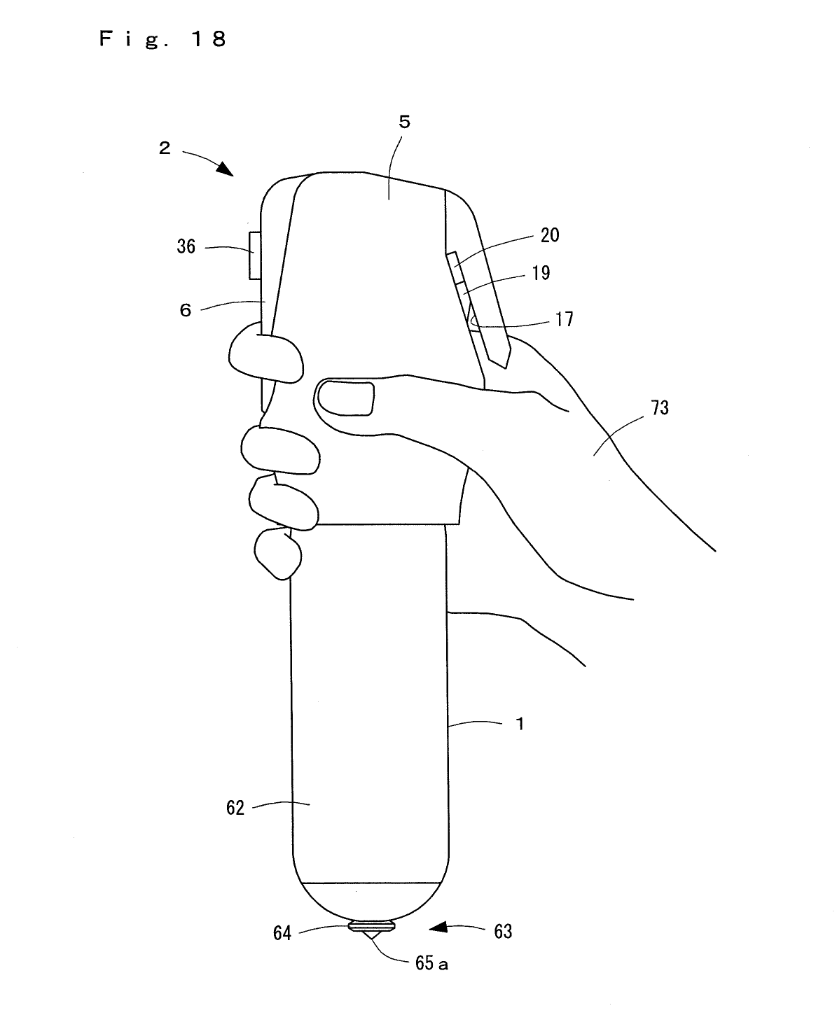

This state is shown in FIG. 16. The edge of the seat belt 72 is cut with the blade 19a of the cutter 19. Then the cut portion of the seat belt 72 is divided in both sides of the cutter 19 and is moved to the back of the seatbelt introduction groove 17. When the cut portion of the seat belt 72 is moved behind the cutter 19, the cutting pressure of the cutter 19 is released, and the internal stress is released and the fiber structure is restored to its original state. Then the cut portion is moved to the distal end of the seatbelt releasing portion 20.

As the distal end moves in the cut portion of the seat belt 72, the cut portion is pushed and spread in right and left. The cut portion moves to the back along both sides of the seatbelt releasing portion 20 or the tapered surfaces 55. The spreading effect of the cut portion reaches the other edge or a portion to be cut of the seat belt 72. Thus, the seat belt 72 is prevented from closely contacting either side of the cutter 19, the seat belt 72 is moved to the back smoothly, and whereby the seat belt 72 can be cut smoothly with the cutter 19.

In this case, there is a clearance between the cutter 19 and the seatbelt releasing portion 20 and the clearance facilitates cutting of the seat belt 72. If the cutter 19 is disposed in close contact with the seatbelt releasing portion 20, the seat belt 72 is stuck between them and cutting is made difficult. On the other hand, to break the windshield 71, the fire extinguisher gas ejector is held with one hand in the same manner as cutting the seat belt 72 with the bottom pointing to a windshield 71 or a side window. The windshield 71 is hit or broken with the pointed portion 65a of the hammer 63. This state is shown in FIG. 17.

In this case, when breaking open the windshield 71 after the seat belt 72 is cut, the user can break the windshield 71 in a continuous movement without shifting the fire extinguisher gas ejector from one hand to the other. Similarly, when cutting the seat belt 72 after the windshield 71 is broken, the user can cut the seat belt 72 in a continuous movement without shifting the fire extinguisher gas ejector from one hand to the other.

Accordingly, the above-described operation can be carried out rapidly and safely compared with the known structure in which the seatbelt introduction groove 17 and the hammer member 63 are disposed on the same side, which is either the upper side or the lower side, and in opposite phases. Further, the hammer member 63 is provided apart from the seatbelt introduction groove 17 and thus the user can break open the windshield 71 reliably and prevents the user from being injured by the broken window pieces. The seal-breaking prevention means 32 is not bent or broken by cutting the seat belt 72 or by the impact of breaking the windshield 71. Thus, there is no danger that the sealing plate would be broken erroneously.

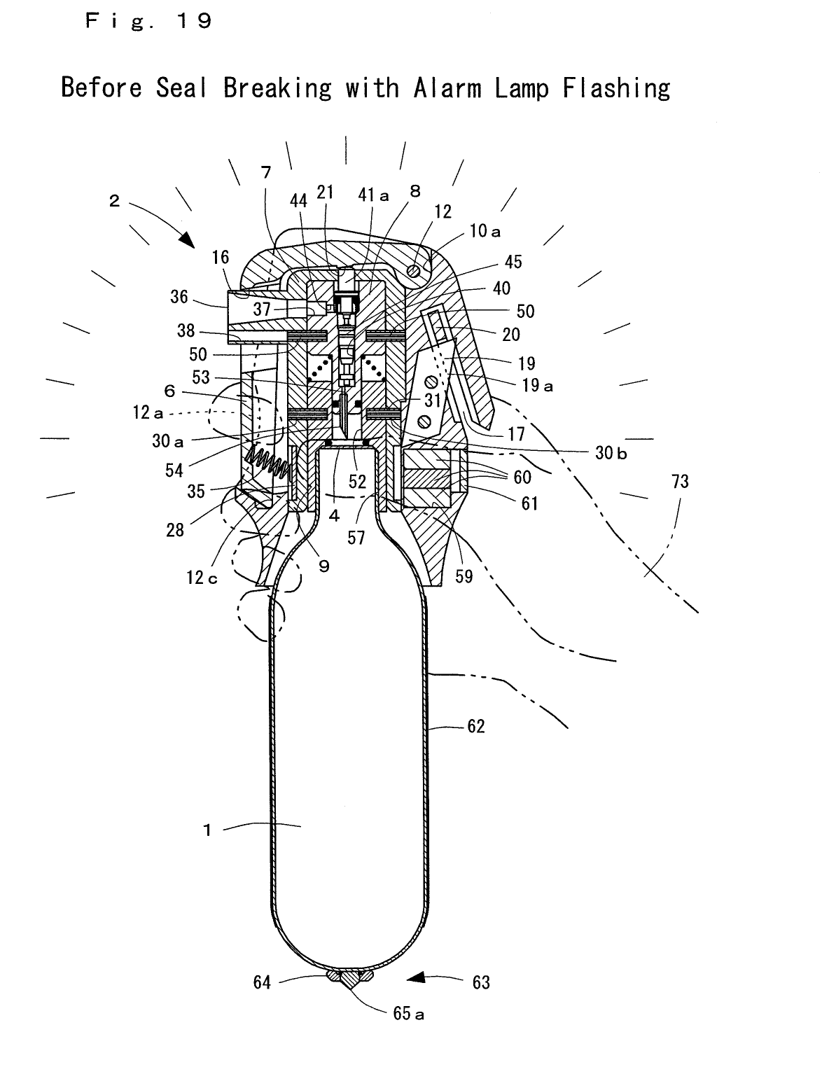

After escaping from the vehicle compartment holding the fire extinguisher gas ejector, for example, the alarm lamps 25 flash to alert persons of an emergency at night. The user can ask for rescue, and emergency measures can be taken so that safety can be ensured in this case, the fire extinguisher gas ejector is held as shown in FIG. 18, and the lower part of the actuation lever 6 is depressed. Then, the actuation lever 6 is rotated downwardly about the pin 15 against the resilience of the spring bearing 41. The lower end of the actuation lever 6 contacts the engaging wall 12e on the inner side and becomes stationary. Power circuits for the alarm lamps 25 are closed by contacting the contact point 35 or a spring with the contact panel 28, and whereby the lamps 25 turn on and flash the red light.

In this case, the contact point 35 is formed by a coil spring so that unsteadiness or deviation in rotational displacement of the actuation lever 6 or some displacement of the contact panel 28 can be tolerated. Thus, this structure provides flexibility in turning on and off the power circuit. In this manner, upon flashing of the alarm lamps 25, the light passes and emits through the housing that is transparent or semi-transparent. This draws people's attention so that people can identify an emergency and thereby ensuring temporary safety of the user and persons and enabling to provide emergency rescue. The user informs persons of an emergency outside of the vehicle holing the fire extinguisher gas ejector in one's hand. In such a situation, for example, a magnet (not shown) may be attached to the appropriate position of the housing 5, and the magnet may be attached to the outer surface of the vehicle. This structure reduces the burden of the above-described trouble. When the actuation lever 6 is rotated in the manner as described, the spring bearing 41 is depressed and whereby the push rod 46 that is immediate below the spring bearing 46 is pressed down to open the control valve 45. The communication hole 40 and the through hole 52 of the cylinder holder 9 are in communication with each other, however, the extinguishing gas is not discharged from the nozzle hole 44 because the sealing plate 4 of the gas cylinder 1 is not broken.

In order to turn off the alarm lamps 25, the actuation lever 6 is released once to separate the contact point 35 from the contact panel 28. Thereafter, the actuation lever 6 is rotated downwardly again to contact the contact point 35 with the contact panel 28. Then, the power circuits for the alarm lamps 25 are open and the alarm lamps 25 are turned off.

On the other hand, the fire extinguisher gas ejector is used to extinguish a fire occurred in a car equipped with the fire extinguisher gas ejector. In order to extinguish a fire, the seal-breaking device 2 is held with one hand, and the gas cylinder 1 is held with the other hand and they are rotated in the opposite directions to each other. Then, the gas cylinder 1 and the cylinder holder 9 into which the gas cylinder 1 is screwed are integrally rotated. As a result, the cam pins 31, 31 protruded from the cylinder holder 9 are guided by the cam grooves 30a, 30h of the cylindrical illuminator 7 and are moved upwardly.

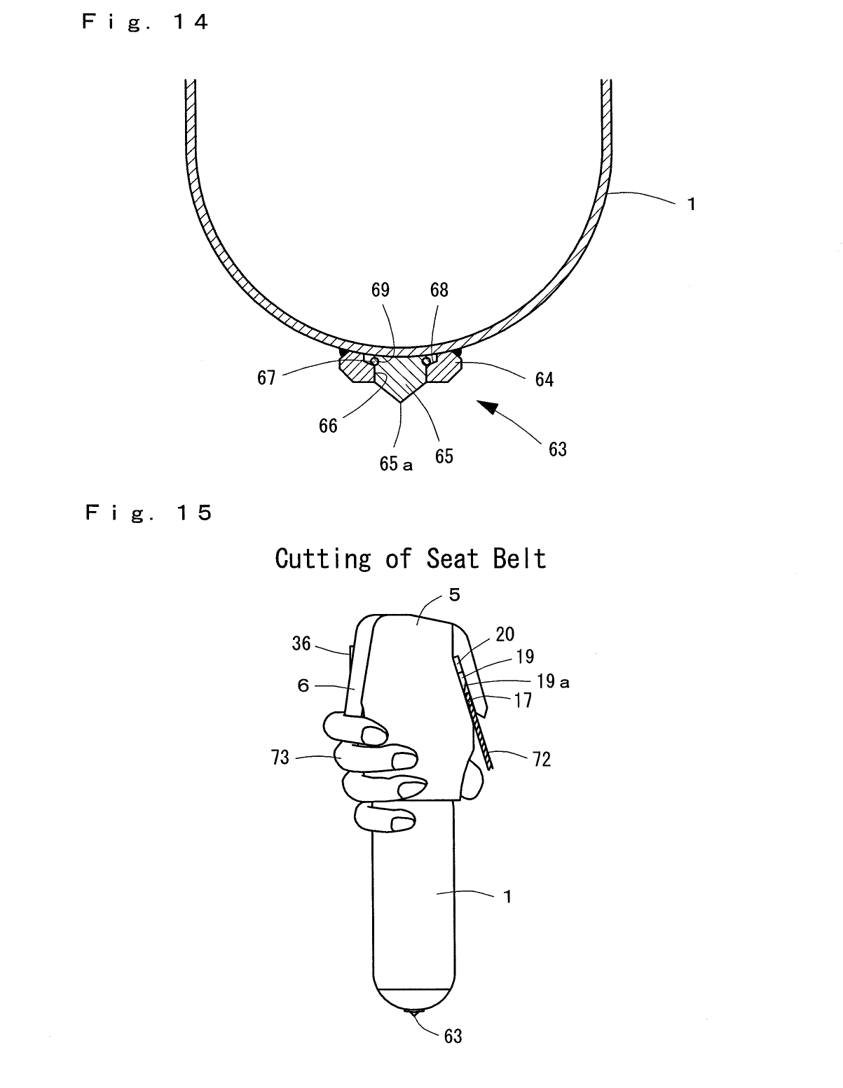

Immediate after moving upward, the can pins 31, 31 are bent or broken engaging with the engaging pieces 32, 32 in this case, the engaging pieces 32, 32 are easily bent or broken due to the cutout grooves 33, 34 formed on both sides of the base part of the protrusion. Then, the gas cylinder 1 and the cam pins 31, 31 are started to move upwardly again and the tip portion 54a of the needle tube 54 is positioned immediate above the sealing plate 4. This state is shown in FIGS. 12 (a), (b), and FIGS. 13 (a), (b).

In this manner, the engaging pieces 32, 32 are engaged with the cam pins 31, 31 and prevent the cam pins 31, 31 from moving upwardly and thus they serve a function as a seal-breaking prevention means. Furthermore, as opposed to the conventional arrangement, the engaging pieces 32, 32 are formed integrally with the cylindrical illuminator 7 and thereby eliminating a need of a separate structure. This structure reduces the number of components, and the structure is simplified and thus the fire extinguisher gas ejector can be made easily and at a low cost.

Additionally, after the engaging pieces 32, 32 are broken, they are retracted in the cutout grooves 34, 34 and passages for the cam pins 31, 31 for moving upwardly are opened. Then the cam pins 31, 31 are moved upwardly again along the cam grooves 30a, 30b and seal breaking operation is started again. Seal breaking prevention and restarting thereof can be carried out serially by a rotational operation of the gas cylinder 1. The seal can be broken more easily and rapidly compared with the conventional structure, in which the seal is broken by separate components. This state is shown in FIGS. 12 (c), (d). After breaking of the engaging pieces 32, 32, they will fall in the cam grooves 30a, 30b as shown in FIG. 12 (d), however, they do not hamper the upward movement and seal breaking operation of the cam pins 31, 31.

When the gas cylinder 1 is rotated about 90 degrees from the starting point, the tip portion 54a of the needle tube 54 pierces the sealing plate 4. This state is shown in FIG. 13 (c). Accordingly, the seal can be broken more easily and rapidly compared with the conventional structure, in which the gas cylinder requires multiple rotations for seal breaking.

After seal breaking, the gas filled in the gas cylinder 1 is introduced from the ruptured portion to the needle tube 54, and then emitted to the communication hole 40 of the seal breaking holder 8. In this case, the push rod 46 maintains its original position and the control valve 45 maintains its closed state. Thus, the emitted gas stays in the lower half of the communication hole 40 and in the through hole 52 of the cylinder holder 9.

After the seal is broken, the fire extinguisher gas ejector is held as shown in FIG. 18, the actuation lever 6 is rotated downwardly about the pin 15 against the resilience of the spring bearing 41. Then, the projection 21 is engaged with the top end of the shaft portion 41a and the spring bearing 41 is depressed. The push rod 46 immediate below the spring bearing 41 is pressed down to open the control valve 45. The communication hole 40 and the through hole 52 of the cylinder holder 9 are in communication with the nozzle hole 40. Thus, the extinguishing gas which stays in the communication hole 40 and the through hole 52 is emitted to a fire origin from the nozzle hole 44. This state is shown in FIG. 20.

As already described, in the fire extinguisher gas ejector, the extinguishing gas emitted after seal breaking stays once in the seal-breaking device 2, and then the gas is emitted the ejector pipe 36 points to a fire origin exactly. Thus, the extinguishing gas is prevented from being wasted so that the extinguishing gas can be used reliably and effectively, and further a fire can be reliably extinguished at the initial stages.

In this case, as the actuation lever 6 is rotated, the lower end of the actuation lever 6 abuts the engaging piece 12c on the inner side and becomes stationary. The contact point 35 which is a coil spring contacts the contact panel 28 and closes the power circuits for the alarm lamps 25. Each alarm lamp 25 is turned on and flashes the red light. Flashing of the alarm lamps 25 informs people of a vehicle fire. After a fire is extinguished, the alarm lamps 25 may be used as an escape lamp and safety for escaping can be ensured.

In this case, apart of the carbon dioxide, or the emitted extinguishing gas is adiabatically expanded and becomes dry ice. This is mixed with gaseous carbon dioxide and then emitted to a fire origin. This lowers the ambient temperature of a fire origin and cuts off oxygen supply to the fire origin and thus contributes to efficient fire extinction. After extinguishing gas is used up, the gas cylinder 1 is removed from the cylinder holder 9 and the empty gas cylinder 1 can be colleted.

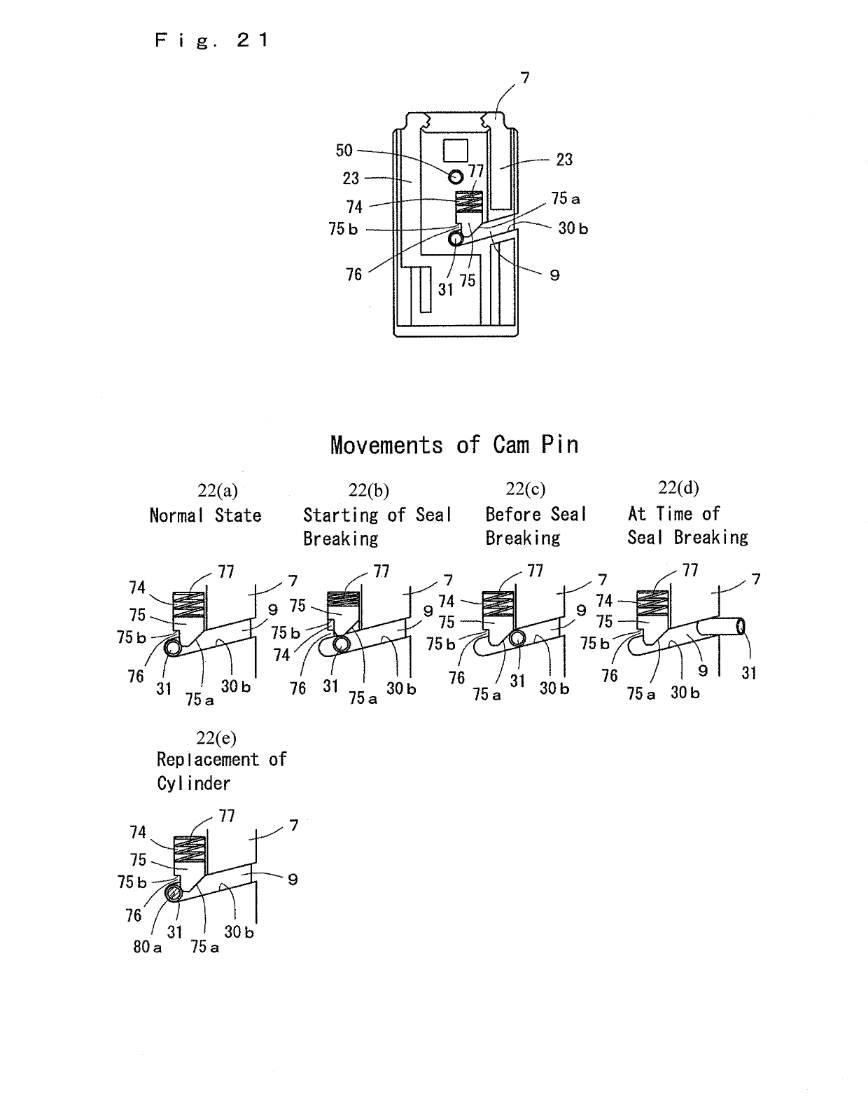

FIGS. 21 to 23 show different embodiments of the present invention, in which the constituent elements corresponding to those of the previous embodiment are given the same reference numerals. In this embodiment, the engaging pieces 32, 32 as described are formed integrally with the cylindrical illuminator 7 to face the cam grooves 30a, 30b. Instead of breaking or bending the engaging pieces 32, 32 after engaging with the cam pins 31, 31 made of spring pins, guide grooves 74, 74 are formed on the middle to the upper peripheral surface of the cylindrical illuminator 7 to face the earn grooves 30a, 30h. Engaging pieces 75, 75 are received in the guide grooves 74, 74 and are slidable up and down. The engaging pieces 75, 75 are made of synthetic-resin plate and formed in substantially a hook shape. Tapered surfaces 75a, 75a are formed respectively at one sides of the lower ends, and neck portions 75b, 75h are formed respectively on the other sides. The neck portions 75b, 75b are positioned to engage with engaging protrusions 76, 76 provided at the lower parts of the guide grooves 74, 74, respectively.

Springs 77 are interposed between the guide grooves 74 and the engaging pieces 75. The engaging pieces 75, 75 are biased downwardly by the resilience of the springs 77. In drawings, reference numeral 78 denotes a sealing ring made of polyurethane rubber provided instead of the O-ring 58 as described and the thickness is thicker than the diameter of the O-ring 58 and a groove for receiving the sealing ring is formed deeper than the groove for the O-ring. Thus, the fitting is improved and thereby preventing falling, twisting, and changing in shape. Provided on the lower part of the actuation lever 6 is a through hole 79. A lock pin 80 is insertable in and out of the through hole 79. The lock pin 80 is formed by a metal rod, such as a steel wire, and a small diameter portion 80a is formed at the end. The small diameter portion 80a is inserted in the earn pin 31 and can be taken out therefrom. This structure prevents the cylinder holder 9 from rotating together with the gas cylinder 1 and prevents seal breaking when the gas cylinder 1 is replaced. The lock pin 80 may be kept attached to the seal-breaking device 2, for example, with a string.

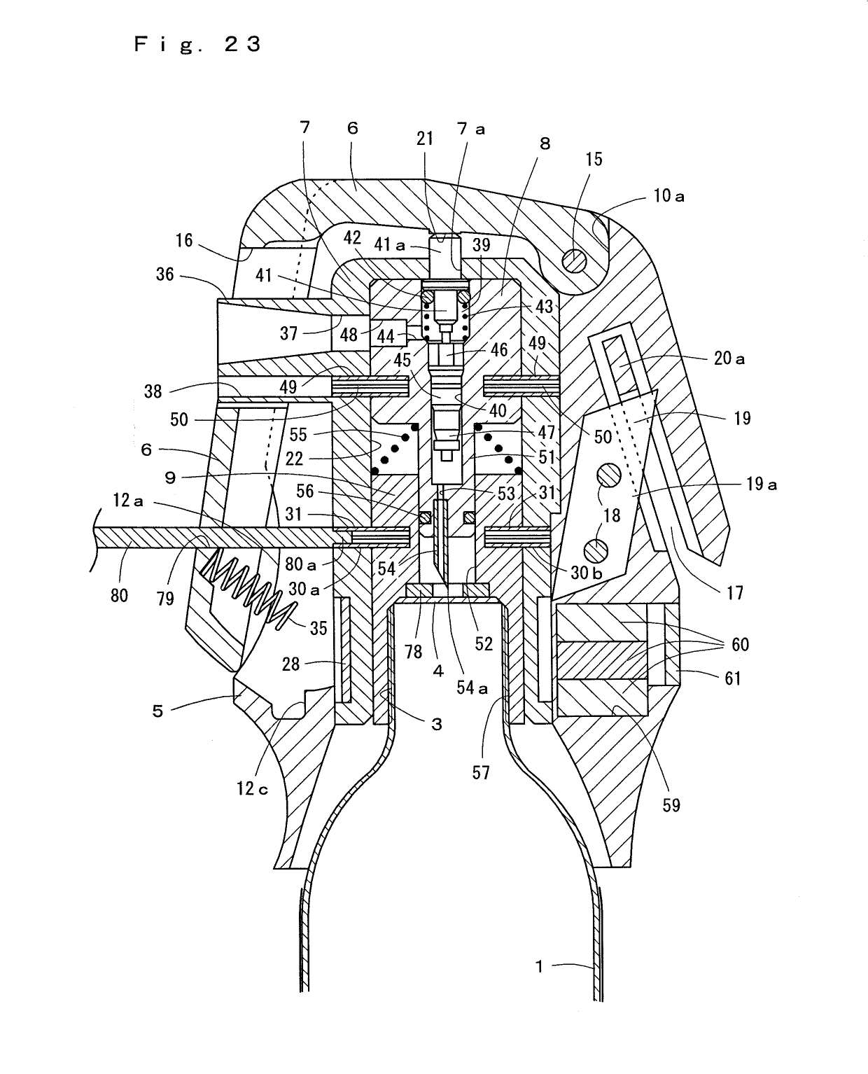

More specifically, in this embodiment, the engaging pieces 75 are normally pressed down by the springs 77 and the lower ends are protruded into the cam grooves 30a, 30b. The side end portions are positioned to engage with the cam pins 31, 31 to prevent upward movement of the cam pins 31, 31. This state is shown in FIG. 22 (a). Upon use of the fire extinguisher gas ejector, the seal-breaking device 2 is held with one hand, the gas cylinder 1 is held with the other hand, in the same manner as described, and they are rotated in the opposite directions to each other. Then, the gas cylinder 1 and the cylinder holder 9 into which the gas cylinder 1 is screwed are integrally rotated. As a result, the cam pins 31, 31 protruded from the cylinder holder 9 are guided by the cam grooves 30a, 30b and are moved upwardly. This state is shown in FIG. 22 (b).

Immediately after the cam pins 31, 31 are moved upwardly, the cam pins 31, 31 are engaged with the engaging pieces 75, 75 and the engaging pieces 75, 75 are moved upwardly against the resilience of the springs 77, 77. After they are moved to the top positions, the cam pins 31, 31 pass under the lower ends of the engaging pieces 75, 75. The tapered surfaces 75a, 75a are engaged with the cant pins 31, 31 and gradually pressed down. The engaging pieces 75, 75 are returned to the original positions immediately before seal breaking. This state is shown in FIG. 22 (c). Thereafter, the gas cylinder 1 is further screwed in the same direction and the seal is broken when rotated about 90 degrees. After the seal is broken, the extinguishing gas is emitted to a fire origin and the gas is used up. This state is shown in FIG. 22 (d).

In order to replace the gas cylinder 1 with a new one after the extinguishing gas is used up, the gas cylinder 1 is rotated in the opposite direction to the above-described direction and then the gas cylinder 1 and the cylinder holder 9 are moved simultaneously. The cam pins 31, 31 are moved downwardly guided by the cam grooves 30a, 30b and engaged with the tapered surfaces 75a, 75a. As a result, the engaging pieces 75, 75 are biased upwardly against the resilience of the springs 77, 77. When the engaging pieces 75, 75 are pushed to the top positions, they are disengaged from cam pins 31, 31 and pushed downwardly by the springs 77, 77 and the engaging pieces 75, 75 return to the original positions. Thereafter, the cam pins 31, 31 are moved to the end of the cant grooves 30a, 30b and become stationary, and whereby the pins 31, 31 are positioned to engage with the engaging pieces 75, 75. This state is shown in FIG. 22 (e). Then, the gas cylinder 1 is further rotated in the same direction to remove the cylinder 1 from the cylinder holder 9.

In these circumstances, the lock pin 80 is inserted in the through hole 79 which is formed at the actuation lever 6. The small-diameter portion 80a, which is the end portion of the lock pin 80, is inserted in one of the cam pins 31 and this state is maintained. In this manner, rotation of the cylinder holder 9 is restricted by the lock pin 80 and movement of the cam pins 31, 31 protruded from the cylinder holder 9 is restricted. In these circumstances, the thread portion 3 of a new gas cylinder 1 is screwed into the thread hole 57 of the cylinder holder 9 and then the gas cylinder 1 moves in the thread hole 57 by screwing.

Then, the lock pin 80 prevents the cylinder holder 9 from rotating together with the gas cylinder 1, and the cam pins 31, 31 become stationary engaging with the engaging pieces 75, 75. Accordingly, the gas cylinder 1 can be replaced safely, because the cylinder holder 9 rotates when the gas cylinder 1 is replaced, and the cam pins 31, 31 are moved simultaneously to push the engaging pieces 75, 75 upwardly, and the cam pins 31, 31 do not move along the cam grooves 30a, 30b. Thus, the sealing plate 4 is not broken by the needle tube 54 because the tip portion 54a of the needle tube 54 is kept at a desired distance. After the gas cylinder 1 is replaced, the lock pin 80 is taken out from the through hole 79 and stored in an appropriate place. Thus, the engaging pieces 75, 75 can be used repeatedly and convenience of the seal-breaking device 2 is enhanced.

The sealing ring 78 is thicker than the diameter of the O-ring 58 and a groove for the sealing ring 78 is deeply formed. Thus, the sealing ring 78 is reliably received in the groove compared with the O-ring 58 and therefore stable sealing effect can be obtained. Thus, as opposed to the conventional manner, the O-ring 58 is prevented from falling when the gas cylinder 1 is removed. Further, the O-ring 58 is prevented from turning up and being changed in shape by contacting the sealing plate 4 when the gas cylinder 1 is replaced. Thus, sealing effect can be maintained and the gas stored therein is prevented from leaking after seal breaking.

### INDUSTRIAL APPLICABILITY

The fire extinguisher gas ejector of the present invention is suitable for a fire extinguisher gas ejector for a vehicle, because it is combined with a device for cutting a seat belt rapidly and a device for breaking open a windshield reliably to facilitate a prompt escape from a vehicle compartment in an emergency, such as a vehicle fire and collision, and the fire extinguisher gas ejector includes a gas cylinder in which a seal can be broken safely and easily without requiring a safety member for preventing seal breaking while not in use and removing, operation thereof, prevents fire extinguishing gas from being wasted after the seal is broken, emits the fire extinguishing gas to a fire origin reliably and accurately, and whereby early fire extinction can be achieved, and further the fire extinguisher gas ejector promptly alerts people of a problem, such as a vehicle fire at night, and ensures an emergency response and safety thereof.

1. A fire extinguisher gas ejector comprising:
a seal-breaking device, the seal-breaking device comprising a housing which defines an outer shape and formed from a translucent member either transparent or semi-transparent;
a gas cylinder filled with fire extinguishing gas, sealed with a sealing plate and provided with a mouth portion removably attached thereto;
a cylinder holder formed therein with a through hole;
a needle tube which slidably moves in the through hole, and provided at a lower end with a tip portion capable of piercing the sealing plate;
a communication hole which is in communication with the needle tube, the through hole, and a nozzle hole which is open to outside; and
a plurality of lamp fittings disposed on an interior of the housing and capable of flashing or lighting.

2. The fire extinguisher gas ejector according to claim 1, further comprising a cylindrical illuminator provided on the interior of the housing, the lamp fittings being disposed on a periphery of the cylindrical illuminator.

3. The fire extinguisher gas ejector according to claim 2, further comprising an actuation lever having a contact point and rotatably provided on the housing, and a contact panel capable of being contacted with the contact point and being provided on the periphery of the cylindrical illuminator.

4. The fire extinguisher gas ejector according to claim 2, wherein the lamp fittings flash or light via rotational operation of the actuation lever before or after seal breaking of the gas cylinder.

5. The fire extinguisher gas ejector according to claim 3, wherein the contact point is formed by either a coil spring or a plate spring

6. The fire extinguisher gas ejector according to claim 2, further comprising two cam pins protruded diametrically from a periphery of the cylinder holder, and two helical cam grooves disposed symmetrically on the periphery of the cylindrical illuminator, wherein the cam pins are slidably engaged with the cam grooves and the cylinder holder is rotatably mounted on an interior of the cylindrical illuminator.

7. The fire extinguisher gas ejector according to claim 6, wherein each cam groove extends about 90 degrees on the periphery of the cylindrical illuminator.

8. The fire extinguisher gas ejector according to claim 6, further comprising an engaging piece engageable with one of the cam pins and protruded from a lower end of each cam groove and capable of being bent or broken.

9. The fire extinguisher gas ejector according to claim 8, wherein the engaging piece and the cylindrical illuminator are formed integrally.

10. The fire extinguisher gas ejector according to claim 6, wherein the engaging piece is movable up and down.

11. The fire extinguisher gas ejector according to claim 10, wherein after seal breaking, the cam pins are moved to a lower end of each cam groove so as to restrict movement of the cam pins, and whereby the gas cylinder is replaceable.

12. The fire extinguisher gas ejector according to claim 11, wherein at least one of the cam pins is formed in a tubular shape, and a lock pin is inserted into the tubular cam pin from outside of the seal-breaking device, whereby the lock pin is restricted.

13. The fire extinguisher gas ejector according to claim 3, wherein the housing is provided at one side thereof with the rotatable actuation lever and at the other side thereof with a seat belt introduction groove, and a cutter is provided to face the seat belt introduction groove.

14. The fire extinguisher gas ejector according to claim 13, further comprising a seat belt releasing portion having a substantially inverted triangular cross section and provided in a rear of the seat belt introduction groove.

15. The fire extinguisher gas ejector according to claim 1, further comprising a battery for the lamp fittings, the battery being received in a lower inside at the other side of the housing.

16. The fire extinguisher gas ejector according to claim 3, wherein the communication hole is provided with a control valve which is normally closed and openable via operation of the actuation lever.

17. The fire extinguisher gas ejector according to claim 1, further comprising a hammer member having a pointed portion provided on a bottom of the gas cylinder for breaking open a windshield of a vehicle.
